(19) United States
(12) Patent Application Publication
(10) Pub. No.: US 2025/0137504 A1
(43) Pub. Date: May 1, 2025

(54) DISC BRAKE AND PLATE

(71) Applicant: HITACHI ASTEMO, LTD., Ibaraki (JP)

(72) Inventors: Miyuki UNO, Hitachinaka-shi (JP); Shinji SUZUKI, Hitachinaka-shi (JP)

(21) Appl. No.: 18/689,466

(22) PCT Filed: Jun. 24, 2022
(86) PCT No.: PCT/JP2022/025373

§ 371 Date: Mar. 6, 2024

(30) Foreign Application Priority Data
Nov. 19, 2021 (JP) 2021-188546

(51) Int. Cl. F16D 65/18; F16D 55/00; F16D 55/226; F16D 65/00; F16D 121/04

(52) U.S. Cl. CPC F16D 65/18; F16D 55/226; F16D 65/0068; F16D 65/0081; F16D 2055/0016; F16D 2055/0037; F16D 2121/04

(57) ABSTRACT

The present disc brake includes a caliper, and a cover member attached to the caliper. The caliper includes a piston pressing a friction pad, a cylinder part having a cylinder hole in which the piston is accommodated, a bridge part provided to straddle an outer circumferential side of a disc from the cylinder part, a claw part provided to face the cylinder part in an axial direction of the cylinder hole from the bridge part, and a recessed portion provided in the claw part to face the cylinder hole. The cover member includes a plate part covering the recessed portion from the axial direction of the cylinder hole, and a locking part restricting movement of the plate part in a rotation direction with respect to an axis of the recessed portion.

### TECHNICAL FIELD

The present invention relates to a disc brake and a plate.

Priority is claimed on Japanese Patent Application No. 2021-188546 filed on Nov. 19, 2021, the content of which is incorporated herein by reference.

### BACKGROUND ART

In a caliper of a disc brake, a technology in which an assembly part is provided with a claw part and is locked to the caliper to improve ease of attachment and detachment of the assembly part has been disclosed (see, for example, Patent Document 1).

### CITATION LIST

### Patent Document

### [Patent Document 1]

Japanese Unexamined Patent Application, First Publication No. 2009-58035

### SUMMARY OF INVENTION

### Technical Problem

Incidentally, there are cases in which a cover member is provided on a caliper for the purpose of improving design quality or the like. In such a case, it is desirable to maintain the cover member in an appropriate state with respect to the caliper.

An objective of the present invention is to provide a disc brake and a plate capable of maintaining a cover member in an appropriate state with respect to a caliper.

### Solution to Problem

In order to achieve the above-described objective, the following aspects are adopted.

That is, a first aspect of the present invention is a disc brake including a caliper, and a cover member attached to the caliper, in which the caliper has a piston pressing a friction pad, a cylinder part having a cylinder hole in which the piston is accommodated, a bridge part provided to straddle an outer circumferential side of a disc from the cylinder part, a claw part provided to face the cylinder part in an axial direction of the cylinder hole from the bridge part, and a recessed portion provided in the claw part to face the cylinder hole, and the cover member has a plate part covering the recessed portion from the axial direction of the cylinder hole, and a locking part restricting movement of the plate part in a rotation direction with respect to an axis of the recessed portion.

A second aspect of the present invention is a plate which is a plate provided in a caliper having a piston pressing a friction pad, a cylinder part having a cylinder hole in which the piston is accommodated, a bridge part provided to straddle an outer circumferential side of a disc from the cylinder part, a claw part provided to face the cylinder part in an axial direction of the cylinder hole from the bridge part, and a recessed portion provided in the claw part to face the cylinder hole, and the plate includes a plate part covering the recessed portion from the axial direction of the cylinder hole, and a locking part restricting movement of the plate part in a rotation direction with respect to an axis of the recessed portion.

### Advantageous Effects of Invention

According to the above-described aspects, the cover member can be maintained in an appropriate state with respect to the caliper.

### BRIEF DESCRIPTION OF DRAWINGS

FIG. 1 is a perspective view illustrating a disc brake of a first embodiment.

FIG. 2 is a front view illustrating the disc brake of the first embodiment.

FIG. 3 is a view illustrating a part of the disc brake of the first embodiment, and is a cross-sectional view along line III-III in FIG. 2.

FIG. 4 is a front view illustrating a claw part and a plate of a caliper body of the disc brake according to the first embodiment.

FIG. 5 is a perspective view illustrating a part of the caliper body and a cover member in the disc brake of the first embodiment.

FIG. 6 is a perspective view illustrating the cover member of the disc brake of the first embodiment.

FIG. 7 is a perspective view illustrating a part of a caliper body and a cover member of a disc brake of a second embodiment.

FIG. 8 is a front view illustrating a claw part and a plate of the caliper body of the disc brake according to the second embodiment.

FIG. 9 is a perspective view illustrating the cover member of the disc brake of the second embodiment.

FIG. 10 is a perspective view illustrating a part of a caliper body and a cover member of a disc brake of a third embodiment.

FIG. 11 is a front view illustrating a claw part and a plate of the caliper body of the disc brake according to the third embodiment.

FIG. 12 is a perspective view illustrating the cover member of the disc brake of the third embodiment.

FIG. 13 is a perspective view illustrating a part of a caliper body and a cover member of a disc brake of a fourth embodiment.

FIG. 14 is a front view illustrating a claw part and a plate of the caliper body of the disc brake according to the fourth embodiment.

FIG. 15 is a perspective view illustrating the cover member of the disc brake of the fourth embodiment.

FIG. 16 is a perspective view illustrating a part of a caliper body and a cover member of a disc brake of a fifth embodiment.

FIG. 17 is a front view illustrating a claw part and a plate of the caliper body of the disc brake according to the fifth embodiment.

FIG. 18 is a perspective view illustrating the cover member of the disc brake of the fifth embodiment.

### DESCRIPTION OF EMBODIMENTS

### First Embodiment

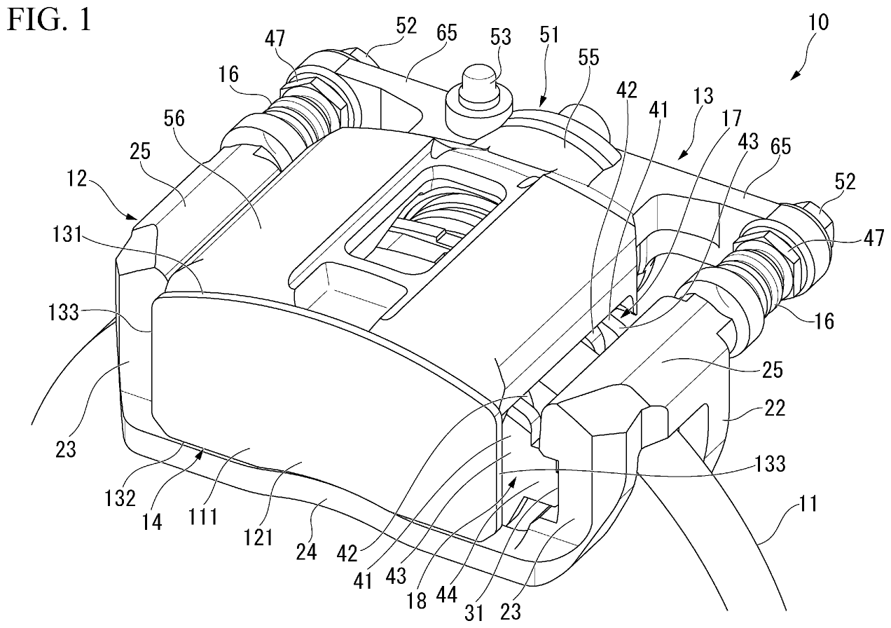

A first embodiment will be described below with reference to FIGS. 1 to 6.

A disc brake 10 of the first embodiment illustrated in FIGS. 1 to 3 is for a vehicle such as an automobile, and applies a braking force to a vehicle. The disc brake 10 is specifically used for braking a four-wheeled vehicle. The disc brake 10 brakes a vehicle by stopping rotation of a disc-shaped disc 11 that rotates together with a wheel (not illustrated).

As illustrated in FIG. 1, the disc brake 10 includes a mounting member 12, a caliper 13, a cover member 14, a pair of boots 16, and a pair of a friction pad 17 and a friction pad 18.

Hereinafter, a central axis of the disc 11 is referred to as a disc axis. Also, a direction in which the disc axis extends, that is, an axial direction of the disc 11 is referred to as a disc axial direction. Also, a radial direction of the disc 11 in the disc brake 10 is referred to as a disc radial direction. Also, a circumferential direction of the disc 11, that is, a rotation direction thereof, in the disc brake 10 is referred to as a disc circumferential direction. Also, a center side of the disc 11 in the disc radial direction is referred to as a disc radial direction inward side. Also, a side opposite to the center of the disc 11 in the disc radial direction is referred to as a disc radial direction outward side. Also, a center side in the disc circumferential direction is referred to as a disc circumferential direction inward side. Also, a side opposite to the center in the disc circumferential direction is referred to as a disc circumferential direction outward side. Also, a line passing through the disc axis and the center of the disc brake 10 in the disc circumferential direction and extending in the disc radial direction is referred to as a radial reference line. The radial reference line is orthogonal to the disc axis. Also, an outer side in a vehicle width direction of the vehicle to which the disc brake 10 is attached is referred to as an outer side. Also, an inner side in the vehicle width direction of the vehicle to which the disc brake 10 is attached is referred to as an inner side.

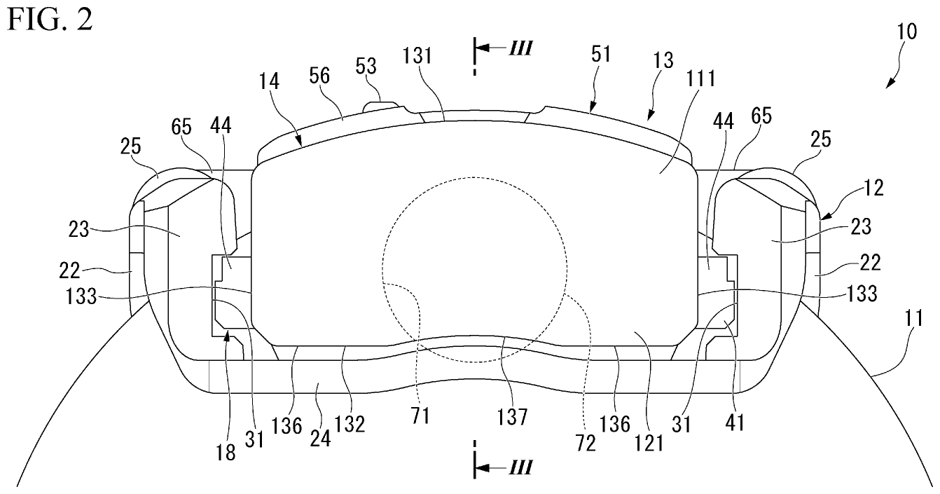

As illustrated in FIG. 2, the mounting member 12 includes a pair of inner pad support parts 22, a pair of outer pad support parts 23, and an outer beam part 24. Also, the mounting member 12 includes a pair of pin insertion parts 25 as illustrated in FIG. 1. Also, the mounting member 12 includes an inner beam part (not illustrated). The mounting member 12 is a casting that is integrally formed by casting. The mounting member 12 has a mirror-symmetrical shape with respect to a plane including both the radial reference line and the disc axis.

As illustrated in FIG. 2, the pair of inner pad support parts 22 are configured such that one inner pad support part 22 is disposed on one side in the disc circumferential direction, and the other inner pad support part 22 is disposed on the other side in the disc circumferential direction. Both the pair of inner pad support parts 22 extend in the disc radial direction. The pair of inner pad support parts 22 are disposed on one side of the disc 11, specifically on the inner side, in the disc axial direction as illustrated in FIG. 1.

The inner beam part (not illustrated) connects end portions of the pair of inner pad support parts 22 on the disc radial direction inward side. The inner beam part extends in the disc circumferential direction. The inner beam part is disposed on the inner side with respect to the disc 11 in the disc axial direction and is fixed to a non-rotating portion of the vehicle. Thereby, the mounting member 12 is fixed to the non-rotating portion of the vehicle.

In the pair of pin insertion parts 25 illustrated in FIG. 1, one pin insertion part 25 extends from an end portion on the disc radial direction outward side of the inner pad support part 22 on one side in the disc circumferential direction. Also, in the pair of pin insertion parts 25, the other pin insertion part 25 extends from an end portion on the disc radial direction outward side of the inner pad support part 22 on the other side in the disc circumferential direction illustrated in FIG. 2. As illustrated in FIG. 1, the pair of pin insertion parts 25 are disposed apart from each other in the disc circumferential direction. The pair of pin insertion parts 25 both extend in the disc axial direction. Both the pair of pin insertion parts 25 straddle an outer circumferential side of the disc 11. Both the pair of pin insertion parts 25 extend from the inner side to the outer side of the disc 11 in the disc axial direction.

In the pair of outer pad support parts 23, the outer pad support part 23 on one side in the disc circumferential direction extends from an end portion on the outer side of the pin insertion part 25 on one side in the disc circumferential direction. In the pair of outer pad support parts 23, the outer pad support part 23 on the other side in the disc circumferential direction extends from an end portion on the outer side of the pin insertion part 25 on the other side in the disc circumferential direction. The pair of outer pad support parts 23 both extend inward in the disc radial direction from the pin insertion part 25. The pair of outer pad support parts 23 are disposed on the outer side with respect to the disc 11.

The outer beam part 24 connects end portions of the pair of outer pad support parts 23 on the disc radial direction inward side. The outer beam part 24 extends in the disc circumferential direction. The outer beam part 24 is disposed on the outer side with respect to the disc 11 similarly to the pair of outer pad support parts 23.

As described above, the mounting member 12 is provided to straddle the outer circumferential side of the disc 11 and is fixed to a non-rotating portion of the vehicle. The inner beam part (not illustrated) and the pair of inner pad support parts 22 are disposed on the inner side of the mounting member 12 which is an attachment side to the non-rotating portion of the vehicle. The pair of outer pad support parts 23 and outer beam parts 24 are disposed on the outer side of the mounting member 12 which is on a side opposite to the inner side.

As illustrated in FIG. 2, pad guide parts 31 are formed in the pair of outer pad support parts 23 on sides facing each other. These pad guide parts 31 have shapes that are recessed in a direction away from each other in the disc circumferential direction. Although not illustrated, similar pad guide parts are also formed on the pair of inner pad support parts 22.

The friction pad 17 and the friction pad 18 illustrated in FIG. 1 are common parts. The friction pads 17 and 18 each have a back plate 41 and a lining 42. The back plate 41 includes a support plate part 43 and a pair of lug parts 44 illustrated in FIG. 2. The pair of lug parts 44 are provided at both end portions of the back plate 41 on the disc circumferential direction outward side. The support plate part 43 illustrated in FIG. 1 is provided between the pair of lug parts 44 illustrated in FIG. 2. As illustrated in FIG. 1, the lining 42 is attached to a surface of the back plate 41 on one side in a thickness direction of the support plate part 43. Thereby, the lining 42 is supported by the support plate part 43.

As illustrated in FIG. 2, of the friction pads 17 and 18, the friction pad 18 disposed on the outer side is configured such that the lug parts 44 at both ends on the disc circumferential direction outward side engage with the pad guide parts 31 of the pair of outer pad support parts 23. The outer friction pad 18 is supported by the pair of outer pad support parts 23 of the mounting member 12 to be movable in the disc axial direction.

Of the friction pads 17 and 18 illustrated in FIG. 1, the friction pad 17 disposed on the inner side is configured such that the lug parts (not illustrated) at both ends on the disc circumferential direction outward side engage with the pad guide parts (not illustrated) of the pair of inner pad support parts 22 illustrated in FIG. 2. The inner friction pad 17 illustrated in FIG. 1 is supported by the pair of inner pad support parts 22 of the mounting member 12 illustrated in FIG. 2 to be movable in the disc axial direction.

As illustrated in FIG. 1, the inner friction pad 17 is disposed to face a surface of the disc 11 on the inner side which is one side in the disc axial direction. The outer friction pad 18 is disposed to face a surface of the disc 11 on the outer side which is the other side in the disc axial direction. The friction pads 17 and 18 both face the disc 11 at the linings 42 thereof. Therefore, the linings 42 of both the friction pads 17 and 18 come into contact with the disc 11. The pair of friction pads 17 and 18 supported by the mounting member 12 are pressed toward the disc 11 by the caliper 13.

In the mounting member 12, pin insertion holes (not illustrated) extending in the disc axial direction are formed from the inner side in the pair of pin insertion parts 25 on both sides in the disc circumferential direction. A pair of slide pins 47 on both sides of the caliper 13 in the disc circumferential direction are fitted into the pin insertion holes to be slidable. Thereby, the mounting member 12 supports the caliper 13 to be slidable in the disc axial direction at the pair of pin insertion parts 25 thereof. In other words, in the caliper 13, the pair of slide pins 47 provided on both sides in the disc circumferential direction are slidably fitted into the pin insertion holes (not illustrated) of the pair of pin insertion parts 25 of the mounting member 12. Thereby, the caliper 13 is supported by the mounting member 12 to be movable in the disc axial direction. The pair of boots 16 each cover a portion of the slide pin 47 protruding from the pin insertion part 25.

The caliper 13 includes a caliper body 51, the pair of slide pins 47, a pair of pin mounting bolts 52, and a bleeder plug 53. The caliper 13 has a mirror-symmetrical shape with respect to a plane including both the radial reference line and the disc axis except for a configuration related to the bleeder plug 53.

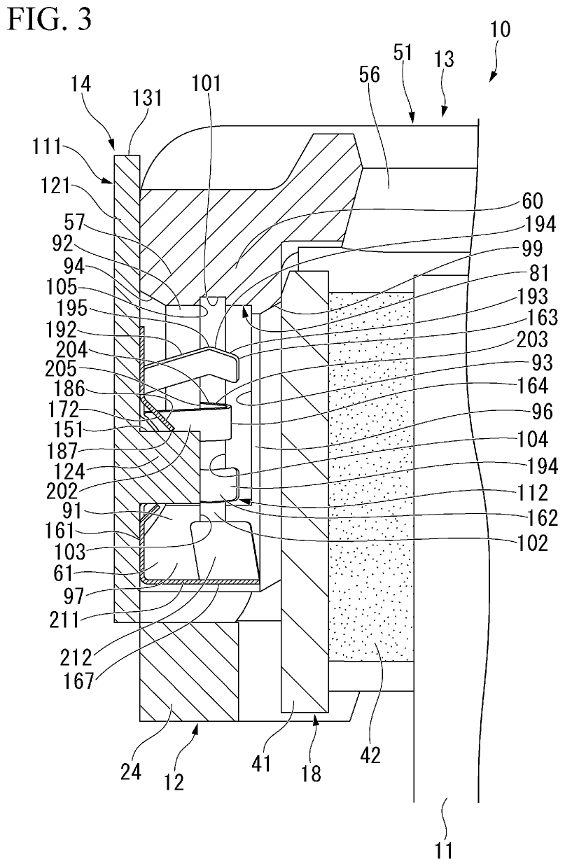

The caliper body 51 is integrally formed by casting. The caliper body 51 includes a cylinder part 55, a bridge part 56, and a claw part 57 which is illustrated in FIGS. 3 to 5. In other words, the caliper 13 including the caliper body 51 has the cylinder part 55 and the bridge part 56 illustrated in FIG. 1, and the claw part 57 illustrated in FIGS. 3 to 5.

The cylinder part 55 illustrated in FIG. 1 is disposed on the inner side with respect to the disc 11 in the disc axial direction. The bridge part 56 extends from a portion of the cylinder part 55 on the disc radial direction outward side to the outer side in the disc axial direction. In other words, the bridge part 56 is provided to straddle the outer circumferential side of the disc 11 from the cylinder part 55. As illustrated in FIG. 3, the claw part 57 illustrated in FIG. 3 extends to the disc radial direction inward side from a side of the bridge part 56 opposite to the cylinder part 55 illustrated in FIG. 1 in the disc axial direction. Thereby, the claw part 57 is disposed on the outer side with respect to the disc 11 in the disc axial direction.

As illustrated in FIG. 1, the caliper body 51 includes a pair of pin attachment parts 65 extending from the cylinder part 55 to both sides in the disc circumferential direction. One slide pin 47 is attached to one pin attachment part 65 of the pair of pin attachment parts 65 by one pin attachment bolt 52. The other slide pin 47 is attached to the other pin attachment part 65 of the pair of pin attachment parts 65 by the other pin attachment bolt 52.

A cylinder hole 71 is formed in the cylinder part 55 as illustrated in FIG. 2. The cylinder hole 71 has a shape having one end opening toward the claw part 57 side illustrated in FIG. 3 and recessed toward a side opposite to the claw part 57 in the disc axial direction. The cylinder hole 71 illustrated in FIG. 2 extends in the disc axial direction. The caliper 13 is a so-called single-bore caliper having one cylinder hole 71.

A piston 72 is disposed in the cylinder hole 71 to be movable in the disc axial direction. In other words, the cylinder part 55 illustrated in FIG. 1 has the cylinder hole 71 in which the piston 72 illustrated in FIG. 2 is accommodated. The caliper 13 includes the piston 72 that is movable in the disc axial direction with respect to the caliper body 51.

The claw part 57 illustrated in FIG. 3 is provided to face the cylinder part 55 illustrated in FIG. 1 from the bridge part 56 in an axial direction of the cylinder hole 71 illustrated in FIG. 2. The claw part 57 illustrated in FIG. 3 overlaps the cylinder part 55 illustrated in FIG. 1 in position in the radial direction of the cylinder hole 71 illustrated in FIG. 2.

As illustrated in FIG. 2, the outer friction pad 18 is supported by the mounting member 12 and is disposed between the claw part 57 and the disc 11 as illustrated in FIG. 3. Also, the inner friction pad 17 illustrated in FIG. 1 is supported by the mounting member 12 and is disposed between the disc 11, and the cylinder part 55 and the piston 72 which is illustrated in FIG. 2 provided in the cylinder part 55. The piston 72 faces the inner friction pad 17 illustrated in FIG. 1 in the disc axial direction. The piston 72 illustrated in FIG. 2 presses the friction pad 17 illustrated in FIG. 1.

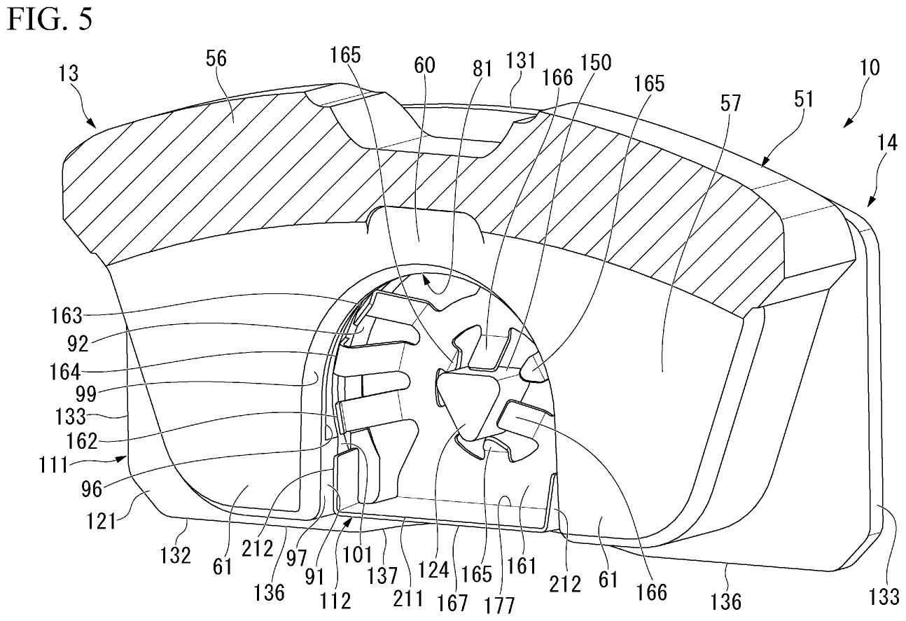

As illustrated in FIG. 5, the claw part 57 includes a base portion 60 and a pair of claw main body portions 61. The base portion 60 is on a side closest to the bridge part 56 in the claw part 57. In other words, the base portion 60 is on an outermost side in the radial direction in the claw part 57. The pair of claw main body portions 61 extend to the disc radial direction inward side from portions on both sides of the bridge part 56 in the disc circumferential direction. That is, one claw main body portion 61 of the pair of claw main body portions 61 extends to the disc radial direction inward side from a portion of the bridge part 56 on one side in the disc circumferential direction. Also, the other claw main body portion 61 of the pair of claw main body portions 61 extends to the disc radial direction inward side from a portion of the bridge part 56 on the other side in the disc circumferential direction. The base portion 60 and the pair of claw main body portions 61 are all positioned on a side of the bridge part 56 opposite to the cylinder part 55 illustrated in FIG. 1 in the disc axial direction. As illustrated in FIG. 3, all the base portion 60 and the pair of claw main body portions 61 extend to the disc radial direction inward side from the bridge part 56 and are positioned on the outer side with respect to the disc 11 in the disc axial direction.

As illustrated in FIG. 5, the pair of claw main body portions 61 are disposed apart from each other in the disc circumferential direction. Thereby, the claw part 57 has a recessed portion 81 formed between the pair of claw main body portions 61 having a shape that penetrates in the disc axial direction and opens inward in the disc radial direction. In other words, the recessed portion 81 is provided between the pair of claw main body portions 61 and has a shape that is recessed from an end portion of the claw part 57 on the disc radial direction inward side toward the disc radial direction outward side. In other words, the recessed portion 81 opens at an end portion on the disc radial direction inward side.

One recessed portion 81 is provided in the claw part 57. The recessed portion 81 is formed in the caliper body 51 to face the cylinder hole 71 illustrated in FIG. 2. The recessed portion 81 illustrated in FIGS. 3 to 5 faces the cylinder hole 71 illustrated in FIG. 2 in the disc axial direction with positions thereof in the disc circumferential direction and disc radial direction overlapping each other. In other words, the recessed portion 81 illustrated in FIGS. 3 to 5 is provided in the claw part 57 illustrated in FIGS. 3 to 5 to face the cylinder hole 71 illustrated in FIG. 2. The recessed portion 81 is a portion through which a tool for processing the inside of the facing cylinder hole 71 illustrated in FIG. 2 is inserted. One recessed portion 81 illustrated in FIGS. 3 to 5, whose number is the same as the number of cylinder holes 71, is provided in the caliper body 51.

As illustrated in FIG. 3, an inner surface 91 of the recessed portion 81 has a main surface portion 92, a stepped surface portion 93, and an outer chamfered portion 94.

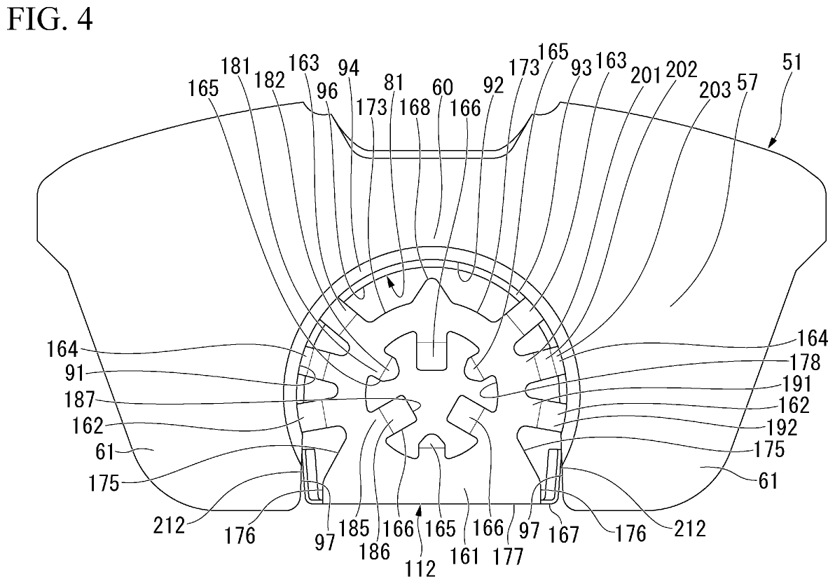

As illustrated in FIG. 4, the main surface portion 92 has a cylindrical surface shape. As illustrated in FIG. 3, the main surface portion 92 is formed at an intermediate portion of the inner surface 91 in the disc axial direction. The main surface portion 92 is a cylindrical surface that is coaxial with a central axis of the cylinder hole 71 illustrated in FIG. 2. In other words, the main surface portion 92 illustrated in FIG. 4 is a cylindrical surface extending in the disc axial direction. The central axis of the cylindrical surface-shaped main surface portion 92 is defined as an axis of the recessed portion 81. The main surface portion 92 is longer than a half of the cylindrical surface in a circumferential direction. In other words, the main surface portion 92 has a central angle of more than 180°.

As illustrated in FIG. 3, the stepped surface portion 93 has a planar shape extending inward in the radial direction of the main surface portion 92 from an end edge portion of the main surface portion 92 on the cylinder part 55 side (right side in FIG. 3) in the disc axial direction. The stepped surface portion 93 is a plane orthogonal to the axis of the recessed portion 81.

The outer chamfered portion 94 is formed to extend from an end edge portion of the main surface portion 92 on a side opposite to the stepped surface portion 93 in the disc axial direction toward a side opposite to the stepped surface portion 93. The outer chamfered portion 94 is a tapered surface in which an inner diameter thereof increases toward a side opposite to the stepped surface portion 93 in the disc axial direction. The outer chamfered portion 94 is a tapered surface that is coaxial with the main surface portion 92.

The inner surface 91 of the recessed portion 81 has a back side surface portion 96, a pair of end side surface portions 97 illustrated in FIG. 4, and an inner chamfered portion 99 illustrated in FIG. 5.

As illustrated in FIG. 3, the back side surface portion 96 is on a side opposite to the main surface portion 92 in an axial direction of the recessed portion 81 with respect to the stepped surface portion 93. As illustrated in FIG. 4, the back side surface portion 96 has a substantially cylindrical surface shape. The main surface portion 92 is recessed from the back side surface portion 96 toward the outside in the radial direction. The back side surface portion 96 has a substantially cylindrical surface shape that is coaxial with the main surface portion 92.

The pair of end side surface portions 97 each extend to the disc radial direction inward side from an inner end edge portion of the main surface portion 92 on the disc radial direction inward side. Both the pair of end side surface portions 97 have a substantially planar shape. Both the pair of end side surface portions 97 extend along the axis of the recessed portion 81. In other words, both the pair of end side surface portions 97 extend in the disc axial direction. The pair of end side surface portions 97 face each other, and a distance therebetween slightly increases toward the disc radial direction inward side. The main surface portion 92 is recessed further outward than the pair of end side surface portions 97 on both sides in the disc circumferential direction.

As illustrated in FIG. 3, the inner chamfered portion 99 is formed to extend through the claw part 57 to a side opposite to the main surface portion 92 from an end edge portion of the back side surface portion 96 on a side opposite to the main surface portion 92 in the axial direction of the recessed portion 81. A portion of the inner chamfered portion 99 extending from the back side surface portion 96 to a side opposite to the main surface portion 92 in the axial direction of the recessed portion 81 is a tapered surface in which an inner diameter thereof increases with distance away from the back surface portion 96 in the axial direction of the recessed portion 81. This portion of the inner chamfered portion 99 is a tapered surface that is coaxial with the main surface portion 92.

The inner surface 91 of the recessed portion 81 has a groove 101 that is recessed outward in a radial direction of the main surface portion 92 from an intermediate portion of the main surface portion 92 in the axial direction of the recessed portion 81. In other words, the recessed portion 81 has the groove 101 on the inner surface 91. The groove 101 extends along the main surface portion 92 and has an arc shape in its entirety. The groove 101 has an arcuate shape that is concentric with the main surface portion 92. In other words, the groove 101 has an arcuate shape centered on the axis of the recessed portion 81. The groove 101 is formed throughout the circumferential direction of the main surface portion 92, and both ends thereof in the circumferential direction overlap the pair of end side surface portions 97 in position in the circumferential direction as illustrated in FIG. 5. In other words, in the groove 101, an intermediate portion in the circumferential direction is formed throughout the circumferential direction of the main surface portion 92, and both end portions in the circumferential direction enter the pair of end side surface portions 97 side with respect to the main surface portion 92. The groove 101 also has a center angle of more than 180° similarly to the main surface portion 92.

As illustrated in FIG. 3, the groove 101 has a groove bottom surface 102 and a pair of wall surfaces 103 and 104. The wall surface 103 of the pair of wall surfaces 103 and 104 is positioned on the outer chamfered portion 94 side in the axial direction of the recessed portion 81. The wall surface 104 of the pair of wall surfaces 103 and 104 is positioned on the inner chamfered portion 99 side in the axial direction of the recessed portion 81. The groove bottom surface 102 has a cylindrical surface shape that is coaxial with the main surface portion 92. In other words, the groove bottom surface 102 has a cylindrical surface shape centered on the axis of the recessed portion 81. The groove bottom surface 102 also has a center angle of more than 180°. The pair of wall surfaces 103 and 104 have a planar shape that extends inward in the radial direction of the groove bottom surface 102 from both end edge portions of the groove bottom surface 102 in the axial direction of the recessed portion 81. The pair of wall surfaces 103 and 104 both have a planar shape that extends orthogonal to a central axis of the groove bottom surface 102. In other words, the pair of wall surfaces 103 and 104 both have a planar shape that extends orthogonal to the central axis of the main surface portion 92. An end edge portion 105 on the main surface portion 92 side of the wall surface 103, in other words, on an inner side of the wall surface 103 in the radial direction, has an arcuate shape. The end edge portion 105 also has a center angle of more than 180°. In the groove 101, a distance between end portions of the groove bottom surface 102 on a side opposite to the bridge part 56 is smaller than a diameter of the groove bottom surface 102.

Here, the outer chamfered portion 94, the back side surface portion 96, and the pair of end side surface portions 97 illustrated in FIG. 4, and the inner chamfered portion 99 illustrated in FIG. 5 can be the same casted surface that has been casted at the time of casting the caliper body 51. On the other hand, the main surface portion 92, the stepped surface portion 93, the groove bottom surface 102 of the groove 101, and the pair of wall surfaces 103 and 104 illustrated in FIG. 3 are cutting machined surfaces formed on the caliper body 51 by cutting machining after casting.

The cover member 14 is attached to the caliper 13 as illustrated in FIGS. 1 to 3 and 5. The cover member 14 is attached to the claw part 57 of the caliper body 51 as illustrated in FIGS. 3 and 5. As illustrated in FIGS. 3, 5, and 6, the cover member 14 includes a cover main body member 111 and a plate 112. The cover main body member 111 and the plate 112 are separate parts.

The cover main body member 111 is an integrally formed product made of a metal such as, for example, an aluminum alloy. The cover main body member 111 has a mirror-symmetrical shape. The cover main body member 111 has a main plate part 121 and a protruding part 124. Further, the cover main body member 111 is not limited to being made of a metal such as an aluminum alloy and may be integrally formed using a material such as a synthetic resin.

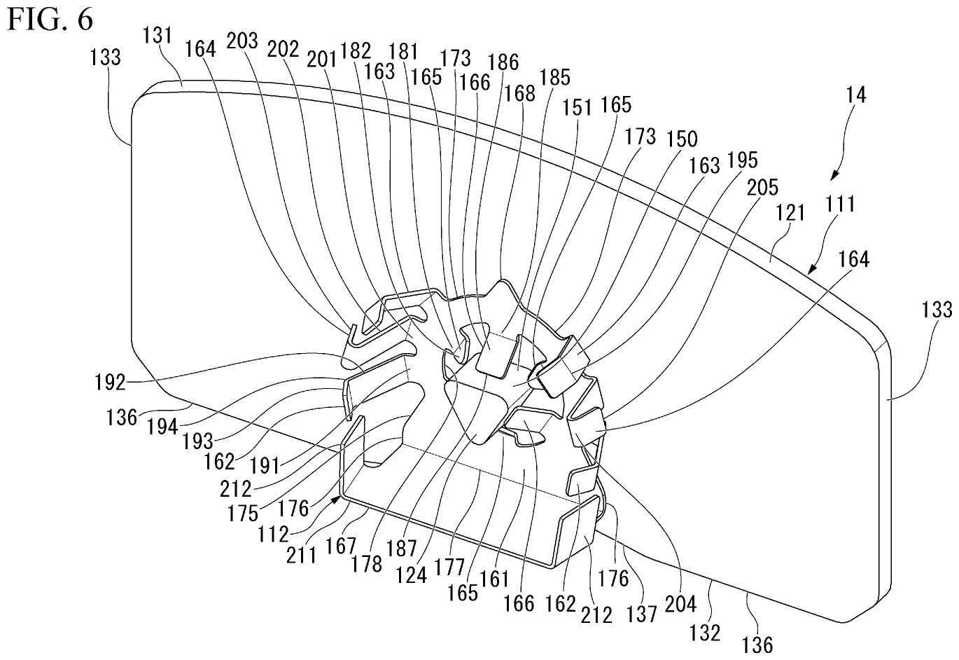

As illustrated in FIG. 6, the main plate part 121 has a substantially rectangular plate shape, and includes a long-side edge portion 131, a long-side edge portion 132, and a pair of short-side edge portions 133 on an outer circumferential portion thereof. One long-side edge portion 131 has an arcuate shape that bulges outward in a direction in which the main plate part 121 extends as a whole. Also, the other long-side edge portion 132 includes a pair of linear end side edge portions 136 disposed on the same straight line, and an arcuate intermediate edge portion 137 that is between the end side edge portions 136 and is recessed toward the inside of the main plate part 121. The pair of short-side edge portions 133 of the main plate part 121 has a linear shape and connect the long-side edge portion 131 and the long-side edge portion 132. The pair of short-side edge portions 133 are parallel to each other. The main plate part 121 has a flat plate shape with a constant thickness.

The protruding part 124 protrudes perpendicular to the main plate part 121 from the main plate part 121. The protruding part 124 are disposed at a position equidistant from the pair of short-side edge portions 133. The protruding part 124 is disposed at an intermediate position between the long-side edge portion 131 and the long-side edge portion 132.

The protruding part 124 has a shape of an equilateral triangular column with an outer circumferential surface 150 having three side surfaces 151. One of the side surfaces 151 of the protruding part 124 is parallel to the end side edge portion 136 and faces in a direction opposite to the end side edge portion 136. In the protruding part 124, a corner between the remaining two side surfaces 151 is directed toward the long-side edge portion 132. Further, the protruding part 124 may be formed such that one side surface 151 is parallel to the end side edge portion 136 and is positioned on the end side edge portion 136 side, and a corner between the remaining two side surfaces 151 is directed toward the long-side edge portion 131.

The plate 112 is formed from a single spring steel plate by press forming. The plate 112 has a mirror-symmetrical shape. As illustrated in FIG. 4, the plate 112 includes a plate part 161, a pair of inwardly bent locking pieces 162, a pair of inwardly bent locking pieces 163, a pair of outwardly bent locking pieces 164, a plurality of (specifically, three) guide pieces 165, a plurality of (specifically, three) fixing pieces 166, an extension part 167, and a protruding part 168. The plate 112 is an integral part in which the plate part 161, the pair of inwardly bent locking pieces 162, the pair of inwardly bent locking pieces 163, the pair of outwardly bent locking pieces 164, the three guide pieces 165, the three fixing pieces 166, the extension part 167, and the protruding part 168 are formed seamlessly.

The protruding part 168 has a flat plate shape with a constant thickness.

The plate part 161 has a bored flat plate shape with a constant thickness. The protruding part 168 is disposed on the same plane as the plate part 161 and protrudes from the plate part 161 toward the outside in a direction in which the plate part 161 extends.

An outer circumferential portion of the plate part 161 includes a pair of arcuate edge portions 173 that are both arcuate, a pair of linear edge portions 175 that are both linear, a pair of linear edge portions 176 that are both linear, and a linear edge portion 177 that is linear.

The pair of arcuate edge portions 173 have a mirror-symmetrical shape and have a shape in which they bulge in a direction opposite to each other. The pair of arcuate edge portions 173 each constitute a part of the same circle. The protruding part 168 protrudes outward in a radial direction of the pair of arcuate edge portions 173 from end portions of the pair of arcuate edge portions 173 on a side proximate to each other.

The pair of linear edge portions 175 extend in a direction opposite to the protruding part 168 from both end portions of the pair of arcuate edge portions 173 on a side opposite to the protruding part 168. The pair of linear edge portions 175 are mirror symmetrical, and a distance therebetween increases with distance away from the protruding part 168.

The pair of linear edge portions 176 extend in a direction opposite to the pair of arcuate edge portions 173 from both end portions of the pair of linear edge portions 175 on a side opposite to the pair of arcuate edge portions 173. The pair of linear edge portions 176 are mirror symmetrical and are parallel to each other.

The linear edge portion 177 connects end portions of the pair of linear edge portions 176 on a side opposite to the pair of linear edge portions 175.

In the plate part 161, an inner circumferential edge portion 178 has a substantially circular shape.

The three guide pieces 165, which are the same number as the number of the corners on the outer circumferential side of the triangular column-shaped protruding part 124 of the cover main body member 111 illustrated in FIG. 5, are provided. As illustrated in FIG. 4, the three guide pieces 165 protrude inward in the radial direction from the inner circumferential edge portion 178 of the plate part 161. The three guide pieces 165 have the same shape. The three guide pieces 165 each have a shape that is directed toward a center of the circle formed by the inner circumferential edge portion 178 when viewed in a thickness direction of the plate part 161. The three guide pieces 165 are disposed at regular intervals in a circumferential direction of the inner circumferential edge portion 178. In other words, the three guide pieces 165 are disposed at intervals of 120° on the inner circumferential edge portion 178.

One guide piece 165 of the three guide pieces 165 is disposed on a line connecting the center of the circle formed by the inner circumferential edge portion 178 and a center of the linear edge portion 177 in a length direction. This guide piece 165 is disposed at a position closest to the linear edge portion 177 on the inner circumferential edge portion 178. This guide piece 165 is disposed at a position farthest from the protruding part 168. The remaining two guide pieces 165 of the three guide pieces 165 are disposed at positions equidistant from the linear edge portion 177. These two guide pieces 165 are also disposed at positions equidistant from the protruding part 168.

The three guide pieces 165 each have an inner base plate part 181 and a guide plate part 182.

As illustrated in FIG. 6, the inner base plate part 181 has a flat plate shape and protrudes inward in a radial direction of the inner circumferential edge portion 178 from the inner circumferential edge portion 178 of the plate part 161 while having the same planar shape as the plate part 161.

The guide plate part 182 has a flat plate shape and extends inward in the radial direction of the inner circumferential edge portion 178 from an end edge portion on a protruding distal end side of the adjacent inner base plate part 181 while being inclined with respect to the plate part 161 and the inner base plate part 181. The guide plate part 182 is inclined so that it becomes further away from the plate part 161 in the thickness direction of the plate part 161 with distance extending from the adjacent inner base plate part 181. The guide plate part 182 has a substantially triangular shape. Further, the guide plate part 182 may not have a substantially triangular shape as long as it has a shape that makes point contact or line contact with the protruding part 124. As illustrated in FIG. 4, the three guide plate parts 182 each have a shape in which an apex point faces toward the center of the circle formed by the inner circumferential edge portion 178. The apex portion of each of the three guide plate part 182 on a protruding distal end side is disposed at each angular position of an equilateral triangle centered on the center of the circle formed by the inner circumferential edge portion 178. A positional relationship between the apex portions of the three guide plate parts 182 is the same as a positional relationship between the three corners on the outer circumferential side of the triangular column-shaped protruding part 124 of the cover main body member 111.

Three fixing pieces 166, which are the same number as the number of the side surfaces 151 of the protruding part 124, are provided in the plate part 161.

The three fixing pieces 166 protrude inward in the radial direction from the inner circumferential edge portion 178 of the plate part 161. The three fixing pieces 166 have the same shape. The three fixing pieces 166 each have a shape that is directed toward the center of the circle formed by the inner circumferential edge portion 178 when viewed in the thickness direction of the plate part 161. The three fixing pieces 166 are alternately disposed with the three guide pieces 165 one by one in the circumferential direction of the inner circumferential edge portion 178. The three fixing pieces 166 are disposed at regular intervals in the circumferential direction of the inner circumferential edge portion 178. In other words, the three fixing pieces 166 are disposed at intervals of 120° on the inner circumferential edge portion 178. The three fixing pieces 166 are each disposed at a position equidistant from the two guide pieces 165 on both sides in the circumferential direction of the inner circumferential edge portion 178. The three fixing pieces 166 and the three guide pieces 165 are configured such that one fixing piece 166 faces one guide piece 165 in the radial direction of the inner circumferential edge portion 178.

One fixing piece 166 of the three fixing pieces 166 is disposed on a line connecting the center of the circle formed by the inner circumferential edge portion 178 of the plate part 161 and a center of the protruding part 168. This fixing piece 166 is disposed at a position farthest from the linear edge portion 177 on the inner circumferential edge portion 178. This fixing piece 166 is disposed at a position closest to the protruding part 168 on the inner circumferential edge portion 178. The remaining two fixing pieces 166 of the three fixing pieces 166 are disposed at positions equidistant from the linear edge portion 177. These two fixing pieces 166 are also disposed at positions equidistant from the protruding part 168.

The three fixing pieces 166 each include an inner base plate part 185 and a fixing plate part 186.

As illustrated in FIG. 6, the inner base plate part 185 has a flat plate shape and protrudes inward in the radial direction of the inner circumferential edge portion 178 from the inner circumferential edge portion 178 of the plate part 161 while having the same planar shape as the plate part 161.

The fixing plate part 186 has a flat plate shape and extends inward in the radial direction of the inner circumferential edge portion 178 from an end edge portion on a protruding distal end side of the adjacent inner base plate part 185 while being inclined with respect to the plate part 161 and the inner base plate part 185. The fixing plate part 186 is inclined so that it becomes further away from the plate part 161 in the thickness direction of the plate part 161 with distance extending from the adjacent inner base plate part 185. The fixing plate part 186 extends to the same side as the guide plate part 182 of the guide piece 165 in the thickness direction of the plate part 161 with respect to the plate part 161. The fixing plate part 186 has a substantially quadrangular shape. A distal end edge portion 187 of the fixing plate part 186 on a side opposite to the adjacent inner base plate part 185 has a linear shape parallel to the plate part 161.

The three fixing pieces 166 extend to the same side with respect to the plate part 161 in a thickness direction thereof. The three distal end edge portions 187 of the three fixing pieces 166 are each disposed to form each side of an equilateral triangle. The equilateral triangle formed by the three distal end edge portions 187 is smaller than the equilateral triangle formed by the three side surfaces 151 of the protruding part 124 by an amount corresponding to a tightening allowance.

In the plate part 161 having the above-described shape, the center of the circle formed by the inner circumferential edge portion 178 is a center portion thereof. The three fixing pieces 166 and the three guide pieces 165 are provided on a center side of the plate part 161.

As described above, the pair of inwardly bent locking pieces 162, the pair of inwardly bent locking pieces 163, and the pair of outwardly bent locking pieces 164 are provided in the plate 112. The pair of inwardly bent locking pieces 162 and the pair of inwardly bent locking pieces 163 all have the same shape. The pair of outwardly bent locking pieces 164 have the same shape. The pair of outwardly bent locking pieces 164 have a different shape from the inwardly bent locking pieces 162 and 163. The pair of inwardly bent locking pieces 162, the pair of inwardly bent locking pieces 163, and the pair of outwardly bent locking pieces 164 extend from the plate part 161 to the same side as the guide plate part 182 and the fixing plate part 186 in the thickness direction of the plate part 161.

One or more inwardly bent locking pieces having the same shape are provided in the plate 112. Specifically, a total of four inwardly bent locking pieces having the same shape including the pair of inwardly bent locking pieces 163 and the pair of outwardly bent locking pieces 164 are provided in the plate 112. One or more outwardly bent locking pieces having the same shape are provided in the plate 112. Specifically, a total of two outwardly bent locking pieces, which are the pair of outwardly bent locking pieces 164, are provided in the plate 112. Two or more locking pieces are provided in the plate 112. Specifically, a total of six locking pieces including the pair of inwardly bent locking pieces 162, the pair of inwardly bent locking pieces 163, and the pair of outwardly bent locking pieces 164 are provided in the plate 112.

One inwardly bent locking piece 162 of the pair of inwardly bent locking pieces 162, one inwardly bent locking piece 163 of the pair of inwardly bent locking pieces 163, and one outwardly bent locking piece 164 of the pair of outwardly bent locking pieces 164 are provided in one arcuate edge portion 173 of the pair of arcuate edge portions 173 of the plate part 161. The other inwardly bent locking piece 162 of the pair of inwardly bent locking pieces 162, the other inwardly bent locking piece 163 of the pair of inwardly bent locking pieces 163, and the other outwardly bent locking piece 164 of the pair of outwardly bent locking pieces 164 are provided in the other arcuate edge portion 173 of the pair of arcuate edge portions 173 of the plate part 161.

The pair of inwardly bent locking pieces 162 are disposed mirror-symmetrically. The pair of inwardly bent locking pieces 163 are disposed mirror-symmetrically. The pair of outwardly bent locking pieces 164 are disposed mirror-symmetrically.

As illustrated in FIG. 4, the pair of inwardly bent locking pieces 162 are disposed on the linear edge portion 177 side with respect to a line passing through the center of the circle formed by the inner circumferential edge portion 178 of the plate part 161 and parallel to the linear edge portion 177. The pair of outwardly bent locking pieces 164 are disposed on the protruding part 168 side with respect to the line passing through the center of the circle formed by the inner circumferential edge portion 178 of the plate part 161 and parallel to the linear edge portion 177. The pair of inwardly bent locking pieces 163 are disposed further on the protruding part 168 side than the pair of outwardly bent locking pieces 164.

The pair of outwardly bent locking pieces 164 are disposed between the pair of inwardly bent locking pieces 162 and the pair of inwardly bent locking pieces 163 in the circumferential direction of the inner circumferential edge portion 178 of the plate part 161. A distance between the pair of outwardly bent locking pieces 164 and the pair of inwardly bent locking pieces 162 is equal to a distance between the pair of outwardly bent locking pieces 164 and the pair of inwardly bent locking pieces 163.

As illustrated in FIG. 6, the inwardly bent locking pieces 162 and 163 each have an outer base plate part 191, an intermediate plate part 192, and a distal end plate part 193.

The outer base plate part 191 of each of the inwardly bent locking pieces 162 and 163 has a flat plate shape, and is disposed on the same plane as the plate part 161. In the inwardly bent locking pieces 162 and 163 provided on the same arcuate edge portion 173, the outer base plate part 191 thereof extends outward from the arcuate edge portion 173 in the radial direction of the arcuate edge portion 173.

The intermediate plate part 192 of each of the inwardly bent locking pieces 162 and 163 has a flat plate shape. The intermediate plate part 192 extends from an end edge portion of the adjacent outer base plate part 191 on an extending distal end side to one side in the thickness direction of the plate part 161. The intermediate plate part 192 of each of the inwardly bent locking pieces 162 and 163 provided on the same arcuate edge portion 173 is inclined so that it is positioned further outward in the radial direction of the arcuate edge portion 173 with distance away from the plate part 161 in the thickness direction of the plate part 161.

The inwardly bent locking pieces 162 and 163 all have a shape in which all the intermediate plate parts 192 become larger in diameter with distance away from the plate part 161 in the thickness direction of the plate part 161 as a whole. The intermediate plate part 192 forms an obtuse angle with the adjacent outer base plate part 191, which is more than 90° and less than 135°.

The distal end plate parts 193 of the inwardly bent locking pieces 162 and 163 have a flat plate shape. The distal end plate parts 193 each extend from an end edge portion of the adjacent intermediate plate part 192 on a side opposite to the outer base plate part 191 adjacent thereto to a side opposite to the plate part 161 in the thickness direction of the plate part 161. The distal end plate parts 193 of the inwardly bent locking pieces 162 and 163 provided on the same arcuate edge portion 173 are each inclined so that it is positioned further inward in the radial direction of the arcuate edge portion 173 with distance away from the plate part 161 in the thickness direction of the plate part 161.

The inwardly bent locking pieces 162 and 163 all have a shape in which all the distal end plate part 193 become smaller in diameter with distance away from the plate part 161 in the thickness direction of the plate part 161 as a whole. An angle formed by the distal end plate part 193 and the intermediate plate part 192 adjacent to each other is an obtuse angle.

In each of the inwardly bent locking pieces 162 and 163, a portion of the intermediate plate part 192 on a side of the distal end plate part 193 adjacent thereto and the distal end plate part 193 constitute a distal end engaging part 194. The distal end engaging part 194 has a shape that is bent to the plate part 161 side in a direction in which the plate part 161 extends.

In each of the inwardly bent locking pieces 162 and 163, a boundary portion 195 on a convex side between the intermediate plate part 192 and the distal end plate part 193 adjacent thereto is linear. The boundary portion 195 is provided at the distal end engaging part 194. All the boundary portions 195 of all the inwardly bent locking pieces 162, 163 are disposed to be tangent to the same circle. All the boundary portions 195 of all the inwardly bent locking pieces 162 and 163 are configured such that both end portions thereof in their extension directions are all disposed on the same circle. A center of this circle is disposed on a central axis of the circle formed by the inner circumferential edge portion 178. A diameter of the circle passing through both end portions of all the boundary portions 195 of all the inwardly bent locking pieces 162 and 163 is larger than a diameter of the end edge portion 105 of the groove 101 of the recessed portion 81 illustrated in FIG. 3. In other words, the diameter of the circle passing through both end portions of all the boundary portions 195 of all the inwardly bent locking pieces 162 and 163 illustrated in FIG. 6 is larger than a diameter of the main surface portion 92 illustrated in FIGS. 3 and 4. Also, edge portions of extending distal ends of all the distal end plate parts 193 of all the inwardly bent locking pieces 162 and 163 illustrated in FIG. 6 are disposed to be tangent to the same circle.

The outwardly bent locking piece 164 includes an outer base plate part 201, an intermediate plate part 202, and a distal end plate part 203.

The outer base plate part 201 of the outwardly bent locking piece 164 has a flat plate shape and is disposed on the same plane as the plate part 161. The outer base plate part 201 of the outwardly bent locking piece 164 extends outward in the radial direction of the arcuate edge portion 173 from the arcuate edge portion 173 on which the outwardly bent locking piece 164 is provided.

The intermediate plate part 202 of the outwardly bent locking piece 164 has a flat plate shape. The intermediate plate part 202 extends from an end edge portion of the adjacent outer base plate part 201 on an extending distal end side to one side in the thickness direction of the plate part 161. The intermediate plate part 202 of the outwardly bent locking piece 164 is inclined so that it is positioned further outward in the radial direction of the arcuate edge portion 173 on which the outwardly bent locking piece 164 is provided with distance away from the plate part 161 in the thickness direction of the plate part 161.

The outwardly bent locking pieces 164 all have a shape in which all the intermediate plate parts 202 become larger in diameter with distance away from the plate part 161 in the thickness direction of the plate part 161 as a whole. The intermediate plate part 202 of the outwardly bent locking piece 164 forms an obtuse angle with the adjacent outer base plate part 201. An angle formed by the intermediate plate part 202 of the outwardly bent locking piece 164 with the adjacent outer base plate part 201 is smaller than an angle formed by the intermediate plate part 192 of each of the inwardly bent locking pieces 162 and 163 with the adjacent outer base plate part 191.

The distal end plate part 203 of the outwardly bent locking piece 164 has a flat plate shape. The distal end plate part 203 of the outwardly bent locking piece 164 extends from an end edge portion of the adjacent intermediate plate part 202 on a side opposite to the outer base plate part 201 adjacent thereto to the outside in the radial direction of the arcuate edge portion 173 on which the outwardly bent locking piece 164 is provided and to the plate part 161 side in the thickness direction of the plate part 161.

The distal end plate part 203 of the outwardly bent locking piece 164 is inclined so that it is positioned further outward in the radial direction of the arcuate edge portion 173 on which the outwardly bent locking piece 164 is provided toward the plate part 161 in the thickness direction of the plate part 161.

The outwardly bent locking pieces 164 all have a shape in which all the distal end plate parts 203 become larger in diameter toward the plate part 161 in the thickness direction of the plate part 161 as a whole. An angle formed by the distal end plate part 203 and the intermediate plate part 202 adjacent to each other is an acute angle.

In the outwardly bent locking piece 164, a portion of the intermediate plate part 202 on a side of the distal end plate part 203 adjacent thereto and the distal end plate part 203 constitute a distal end engaging part 204. The distal end engaging part 204 has a shape that is bent to a side opposite to the plate part 161 in a direction in which the plate part 161 extends.

In the outwardly bent locking piece 164, a distal end edge portion 205 of the distal end plate part 203 on a side opposite to the adjacent intermediate plate part 202 is linear. The distal end edge portion 205 is provided on the distal end engaging part 204. All the distal end edge portions 205 of all the outwardly bent locking pieces 164 are disposed to be tangent to the same circle. A center of this circle is positioned on the central axis of the circle formed by the inner circumferential edge portion 178. A diameter of the circle through which both end portions of all the distal end edge portions 205 of all the outwardly bent locking pieces 164 pass is larger than the diameter of the end edge portion 105 of the groove 101 of the recessed portion 81 illustrated in FIG. 3. In other words, the diameter of the circle through which both end portions of all the distal end edge portions 205 of all the outwardly bent locking pieces 164 illustrated in FIG. 6 pass is larger than the diameter of the main surface portion 92 illustrated in FIGS. 3 and 4.

As illustrated in FIG. 6, the extension part 167 includes a guard plate part 211 and a pair of locking parts 212. Therefore, two locking parts 212 are provided for one plate part 161.

The extension part 167 is provided on the linear edge portion 177 of the plate part 161. The guard plate part 211 of the extension part 167 extends from the linear edge portion 177 of the plate part 161. The guard plate part 211 has a substantially rectangular flat plate shape. The guard plate part 211 extends along the linear edge portion 177 of plate part 161. The guard plate part 211 extends perpendicular to the plate part 161 from the linear edge portion 177. The guard plate part 211 extends from the plate part 161 to the same side as the pair of inwardly bent locking pieces 162, the pair of inwardly bent locking pieces 163, and the pair of outwardly bent locking pieces 164 in the thickness direction of the plate part 161.

The pair of locking parts 212 have the same shape. The pair of locking parts 212 are provided at both end edge portions of the guard plate part 211 in a direction in which the linear edge portion 177 extends. The pair of locking parts 212 are provided at a portion of the guard plate part 211 on a side opposite to the plate part 161 in the thickness direction of the plate part 161. The pair of locking parts 212 each have a rectangular flat plate shape. The pair of locking parts 212 are disposed mirror-symmetrically. The pair of locking parts 212 extend from the guard plate part 211 to a side of the inwardly bent locking pieces 162 and 163 and the outwardly bent locking piece 164 in a thickness direction of the guard plate part 211.

Boundary lines of the pair of locking parts 212 with the plate part 161 become closer in the direction in which the linear edge portion 177 extends with distance away from the plate part 161 in the thickness direction of the plate part 161.

Also, a distance between the pair of locking parts 212 in the direction in which the linear edge portion 177 extends increases with distance away from the guard plate part 211 in the thickness direction of the guard plate part 211. In other words, each of the pair of locking parts 212 forms the same obtuse angle with the guard plate part 211.

In a state before the plate 112 is assembled to the caliper body 51 illustrated in FIG. 4 or the like, a maximum distance between the pair of locking parts 212 at a position farthest from the plate part 161 in the thickness direction of the plate part 161 illustrated in FIG. 6 is smaller than a minimum distance between the pair of end side surface portions 97 of the caliper body 51 illustrated in FIG. 4. Thereby, the pair of locking parts 212 can be easily inserted between the pair of end side surface portions 97 starting from the position farthest from the plate part 161. Further, after the pair of locking parts 212 are inserted between the pair of end side surface portions 97, they are in contact with the pair of end side surface portions 97 as illustrated in FIG. 4. At that time, the pair of locking parts 212 elastically deform in a direction toward each other.

As illustrated in FIG. 6, the plate 112 is fitted onto the protruding part 124 of the cover main body member 111. Thereby, the plate 112 is fixed to the cover main body member 111 to form the cover member 14. That is, the plate 112 has a posture with the plate part 161 at the front in the fitting direction and is fitted onto the protruding part 124 while the three fixing pieces 166 are elastically deformed. At that time, the plate 112 has a posture in which the protruding part 168 is disposed toward the long-side edge portion 131 of the long-side edge portion 131 and the long-side edge portion 132 of the cover main body member 111, and the linear edge portion 177 is disposed on the long-side edge portion 132 side of the long-side edge portion 131 and the long-side edge portion 132. Also, at that time, the plate 112 has a posture in which the linear edge portion 177 and the guard plate part 211 are parallel to the end side edge portion 136 of the long-side edge portion 132. Also, at that time, in the plate 112, the distal end edge portions 187 of the three fixing pieces 166 are each brought into line contact with the corresponding one of the three side surfaces 151 of the protruding part 124. At the same time, in the plate 112, the three guide pieces 165 are guided by the three guide plate parts 182 to move to the three corners of the outer circumferential surface 150 of the protruding part 124. Then, the plate 112 is fitted onto the protruding part 124 until the plate part 161 comes into contact with the main plate part 121. Then, the three distal end edge portions 187 of the plate 112 each come into line contact with a corresponding one of the three side surfaces 151 of one of the protruding part 124 with a fastening allowance. Thereby, the plate 112 is locked and fixed to the cover main body member 111 by an elastic force of the three fixing pieces 166. Therefore, the plate 112 is fixed to the cover main body member 111 with the plate part 161 in surface contact with the main plate part 121.

In this way, the plate 112 is fixed to the cover main body member 111 to form the cover member 14. In this state, the plate 112 is configured such that the pair of inwardly bent locking pieces 162, the pair of inwardly bent locking pieces 163, the pair of outwardly bent locking pieces 164, and the extension part 167 extend to the same side as the protruding part 124 from the main plate part 121 of the cover main body member 111.

Then, the cover member 14 is assembled to the caliper 13 as illustrated in FIGS. 1 to 3 and 5. Specifically, the cover member 14 is assembled to the claw part 57 of the caliper body 51 as illustrated in FIGS. 3 and 5. At that time, the cover member 14 is assembled to the claw part 57 from a side opposite to the cylinder part 55 illustrated in FIG. 1 in the axial direction of the recessed portion 81.

When the cover member 14 is assembled to the claw part 57, the cover member 14 has a posture in which the pair of inwardly bent locking pieces 162, the pair of inwardly bent locking pieces 163, the pair of outwardly bent locking pieces 164, and the extension part 167 of the plate 112 illustrated in FIG. 6 are at the front in an assembly direction, and the main plate part 121 of the cover main body member 111 is at the rear in the assembly direction. At the same time, the cover member 14 has a posture in which a center of the inner circumferential edge portion 178 of the plate 112 is positioned approximately on the axis of the recessed portion 81, and the extension part 167 is positioned at a position farthest from the base portion 60 in the plate 112.

In this state, the cover member 14 is moved to the recessed portion 81 in the axial direction of the recessed portion 81. Then, in the cover member 14, first, the pair of locking parts 212 of the extension part 167 of the plate 112 are inserted into the recessed portion 81. As the cover member 14 continues to move to the recessed portion 81 side, the pair of locking parts 212 come into contact with end edge portions of the pair of end side surface portions 97 on a side opposite to the cylinder part 55. As the cover member 14 continues to move further to the recessed portion 81 side, the pair of locking parts 212 ride on the pair of end side surface portions 97 of the recessed portion 81 while being elastically deformed toward each other due to their inclinations. Thereby, the pair of locking parts 212 come into contact with the pair of end side surface portions 97 of the recessed portion 81 with a fastening allowance.

As the cover member 14 continues to move to the recessed portion 81 side after the insertion of the pair of locking parts 212 into the recessed portion 81 has started as described above, the pair of inwardly bent locking pieces 162 and the pair of inwardly bent locking pieces 163 of the plate 112 come into contact with the outer chamfered portion 94 of the recessed portion 81 at the distal end plate parts 193. At the same time, the pair of outwardly bent locking pieces 164 of the plate 112 come into contact with the outer chamfered portion 94 of the recessed portion 81 at the distal end plate parts 203.

As the cover member 14 continues to move further to the recessed portion 81 side, the pair of inwardly bent locking pieces 162 and the pair of inwardly bent locking pieces 163 of the plate 112 ride on the main surface portion 92 of the recessed portion 81 at the boundary portions 195 while elastically deforming to the protruding part 124 side due to the inclination of the outer chamfered portion 94 and the inclination of the distal end plate part 193. At the same time, the pair of outwardly bent locking pieces 164 of the plate 112 ride on the main surface portion 92 of the recessed portion 81 at the distal end edge portions 205 while elastically deforming to the protruding part 124 side due to the inclination of the outer chamfered portion 94 and the inclination of the distal end plate part 203.

As the cover member 14 continues to move further to the recessed portion 81 side, the boundary portion 195 of each of the pair of inwardly bent locking pieces 162 and the pair of inwardly bent locking pieces 163 in the plate 112 reaches a position of the groove 101 of the recessed portion 81. Then, the pair of inwardly bent locking pieces 162 and the pair of inwardly bent locking pieces 163 slightly return their elastic deformation. Thereby, the distal end engaging part 194 of each of the pair of inwardly bent locking pieces 162 and the pair of inwardly bent locking pieces 163 comes into contact with the end edge portion 105 of the wall surface 103 of the groove 101 on the main surface portion 92 side at the intermediate plate part 192. At this time, the boundary portion 195 of each of the pair of inwardly bent locking pieces 162 and the pair of inwardly bent locking pieces 163 overlaps the wall surface 103 in position in the radial direction of the wall surface 103. Also, at this time, the elastic forces of the pair of inwardly bent locking pieces 162 and the pair of inwardly bent locking pieces 163 cause the distal end engaging parts 194 to be pressed against and come into contact with the end edge portion 105 of the groove 101 of the recessed portion 81 at the intermediate plate part 192.

In parallel with the above, in the plate 112, the distal end edge portions 205 of the pair of outwardly bent locking pieces 164 reach the position of the groove 101 of the recessed portion 81, and thereby the pair of outwardly bent locking pieces 164 slightly return the elastic deformation. Then, the distal end edge portions 205 of the pair of outwardly bent locking pieces 164 enter the inside of the groove 101 to come into contact with and face the wall surface 103 of the groove 101 in the disc axial direction. In other words, the distal end edge portions 205 of the pair of outwardly bent locking pieces 164 overlap the wall surface 103 in position in the radial direction of the wall surface 103. Also, at this time, the elastic forces of the outwardly bent locking pieces 164 cause the distal end edge portions 205 to be pressed against and come into contact with the groove bottom surface 102 of the groove 101 of the recessed portion 81.

Here, the distal end edge portions 205 of the pair of outwardly bent locking pieces 164 of the plate 112 enter the inside of the groove 101 and come into contact with the wall surface 103, and at the same time, the cover main body member 111 comes into contact with the bridge part 56 and the claw part 57 of the caliper 13 at the main plate part 121 and stops. In this way, the cover member 14 is attached to the caliper 13. In an assembled state in which the cover member 14 is assembled to the caliper 13 in this manner, the pair of locking parts 212 of the cover member 14 are in contact with the pair of end side surface portions 97 of the recessed portion 81 with a fastening allowance.

In the cover member 14 in the assembled state, as illustrated in FIG. 5, the cover main body member 111 covers the recessed portion 81 from the outside on a side opposite to the cylinder part 55 in the disc axial direction. That is, in the cover main body member 111, the main plate part 121 overlaps the recessed portion 81 in position in the disc circumferential direction and the disc radial direction. Also, in this assembled state, in the cover member 14, the plate part 161 of the plate 112 covers the recessed portion 81 from the axial direction of the recessed portion 81, in other words, from the axial direction of the cylinder hole 71. At that time, the plate part 161 covers the recessed portion 81 from a side opposite to the cylinder part 55 in the disc axial direction. That is, in the plate 112, the plate part 161 overlaps the recessed portion 81 in position in the disc circumferential direction and the disc radial direction. In this assembled state, the plate 112 of the cover member 14 fixes the cover main body member 111 to the caliper 13.

In the cover member 14 in the assembled state, the pair of inwardly bent locking pieces 162 and the pair of inwardly bent locking pieces 163 cause the boundary portions 195 to enter the inside of the groove 101 at the distal end engaging parts 194 due to the elastic force to maintain the intermediate plate parts 192 in a state of being in contact with the end edge portion 105 of the groove 101.

Here, in the cover member 14 in the assembled state, all the intermediate plate parts 192 of the pair of inwardly bent locking pieces 162 and the pair of inwardly bent locking pieces 163 of the plate 112 are inclined such that a diameter thereof increases with distance away from the main plate part 121 as a whole. Therefore, the elastic force of the pair of inwardly bent locking pieces 162 and the pair of inwardly bent locking pieces 163 generates a component in a direction in which the main plate part 121 is brought into contact with the bridge part 56 and the claw part 57. As a result, in the cover member 14 in the assembled state, the plate 112 causes the main plate part 121 of the cover main body member 111 to be in contact with, in other words, in close contact with the bridge part 56 and the claw part 57 with the elastic force.

In the cover member 14 in the assembled state, the pair of outwardly bent locking pieces 164 of the plate 112 restrict movement in a direction opposite to the cylinder part 55 from the claw part 57 by coming into contact with the wall surface 103 of the groove 101 to which the claw part 57 engages.

In the plate 112 of the cover member 14 in the assembled state, the inwardly bent locking pieces 162 and 163 extend from the plate part 161 to approach the cylinder hole 71 in the axial direction of the cylinder hole 71. In the plate 112 of the cover member 14 in the assembled state, the distal end engaging parts 194 of the inwardly bent locking pieces 162 and 163 are bent inward in the radial direction of the cylinder hole 71. In the plate 112 of the cover member 14 in the assembled state, the distal end engaging parts 194 of the inwardly bent locking pieces 162 and 163 come into contact with the end edge portion 105 of the groove 101 at the intermediate plate parts 192.

In the plate 112 of the cover member 14 in the assembled state, the outwardly bent locking piece 164 extends from the plate part 161 to approach the cylinder hole 71 in the axial direction of the cylinder hole 71. In the plate 112 of the cover member 14 in the assembled state, the distal end engaging part 204 of the outwardly bent locking piece 164 is bent outward in the radial direction of the cylinder hole 71. In the plate 112 of the cover member 14 in the assembled state, the distal end engaging part 204 of the outwardly bent locking piece 164 is in contact with the wall surface 103 of the groove 101 at the distal end edge portion 205.

In the cover member 14 in the assembled state, an axis passing through the center of the inner circumferential edge portion 178 of the plate part 161 and extending along the radial reference line is defined as a first axis, and an axis orthogonal to the first axis, passing through the center of the inner circumferential edge portion 178, and extending in a direction orthogonal to the disc axis is defined as a second axis. Then, in the plate 112 of the cover member 14 in the assembled state, the pair of inwardly bent locking pieces 162 are disposed to sandwich the first axis therebetween when viewed from the disc axial direction, and are disposed to overlap each other when viewed from a direction of the second axis. Also, in the plate 112 of the cover member 14 in the assembled state, the pair of inwardly bent locking pieces 163 are disposed to sandwich the first axis therebetween when viewed from the disc axial direction, and are disposed to overlap each other when viewed from the direction of the second axis. Also, in the plate 112 of the cover member 14 in the assembled state, the pair of outwardly bent locking pieces 164 are disposed to sandwich the first axis therebetween when viewed from the disc axial direction, and are disposed to overlap each other when viewed from the direction of the second axis.

Also, in the plate 112 of the cover member 14 in the assembled state, the pair of inwardly bent locking pieces 162 are disposed on a side opposite to the bridge part 56 with respect to the center of the inner circumferential edge portion 178 of the plate part 161 in a direction of the first axis when viewed from the disc axial direction. Also, in the plate 112 of the cover member 14 in the assembled state, the pair of inwardly bent locking pieces 163 are disposed on the bridge part 56 side with respect to the center of the inner circumferential edge portion 178 of the plate part 161 in the direction of the first axis when viewed from the disc axial direction. Also, in the plate 112 of the cover member 14 in the assembled state, the pair of outwardly bent locking pieces 164 are disposed on the bridge part 56 side with respect to the center of the inner circumferential edge portion 178 of the plate part 161 in the direction of the first axis when viewed from the disc axial direction.

Also, the cover main body member 111 of the cover member 14 in the assembled state includes the protruding part 124 extending from the main plate part 121 to approach the cylinder hole 71 in the axial direction of the cylinder hole 71. In the plate 112 of the cover member 14 in the assembled state, the plurality of guide pieces 165 and the plurality of fixing pieces 166 that are in contact with the outer circumferential surface 150 of the protruding part 124 are provided on the center side of the plate part 161 of the plate 112.

Also, in the cover member 14 in the assembled state, the plurality of inwardly bent locking pieces 162 and 163 and outwardly bent locking pieces 164 of the plate 112 extend from the plate part 161 in the axial direction of cylinder hole 71, in other words, in a direction inclined with respect to a moving direction of the piston 72.

Also, in the assembled state, the inwardly bent locking pieces 162 and 163 and the outwardly bent locking pieces 164 of the plate 112 of the cover member 14 are in contact with the inner surface 91 of the recessed portion 81 with an elastic force.

Also, in the assembled state, the inwardly bent locking pieces 162 and 163 and the outwardly bent locking pieces 164 of the plate 112 of the cover member 14 are in contact with the groove 101 of the recessed portion 81.

Also, in the cover member 14 in the assembled state, the cover main body member 111 is in contact with the bridge part 56 at least on an outer side in the disc radial direction with respect to the protruding part 124 to which the plate 112 is fixed.

Also, in the assembled state, the pair of locking parts 212 of the plate 112 of the cover member 14 restrict movement of the plate part 161 in a rotation direction with respect to the axis of the recessed portion 81. That is, in the plate 112, one locking part 212 of the pair of locking parts 212 comes into contact with one end side surface portion 97 of the pair of end side surface portions 97 of the recessed portion 81. Thereby, the plate 112 restricts movement of the plate part 161 to one side in the rotation direction with respect to the axis of the recessed portion 81. At the same time, the other of the pair of locking parts 212 of the plate 112 comes into contact with the other of the pair of end side surface portions 97 of the recessed portion 81. Thereby, the plate 112 restricts movement of the plate part 161 to the other side in the rotation direction with respect to the axis of the recessed portion 81. In this way, the pair of locking parts 212 of the plate 112 restrict movement of the plate part 161 in the rotation direction with respect to the axis of the recessed portion 81. In other words, the pair of locking parts 212 restrict movement of the plate part 161 in the rotation direction with respect to the axis of the recessed portion 81 by coming into contact with the pair of end side surface portions 97 of the recessed portion 81. In yet other words, the pair of locking parts 212 restrict rotation of the plate 112 centered on the axis of the recessed portion 81 and furthermore rotation of the cover member 14 by coming into contact with the pair of end side surface portions 97 of the recessed portion 81.

Also, in the assembled state, the guard plate part 211 of the cover member 14 covers the recessed portion 80 from the disc radial direction inward side.

In the disc brake 10, a brake fluid is introduced into the cylinder hole 71 of the cylinder part 55 of the caliper 13 via a brake pipe (not illustrated). Then, a brake hydraulic pressure acts on the piston 72 in the cylinder hole 71. As a result, the piston 72 moves forward to the disc 11 side. Then, of the friction pads 17 and 18, the piston 72 presses the inner friction pad 17 disposed between the piston 72 and the disc 11 toward the disc 11. Thereby, the friction pad 17 moves in the disc axial direction and comes into contact with a surface of the disc 11 on the inner side. In other words, the piston 72 that moves the inner friction pad 17 of the friction pads 17 and 18 is disposed in the cylinder hole 71 of the cylinder part 55.

Also, due to a reaction force of this pressing, the caliper body 51 slides the slide pin 47 with respect to the mounting member 12 and moves it in the disc axial direction. Then, the claw part 57 of the caliper body 51 presses the outer friction pad 18 of the friction pads 17 and 18, which is disposed between the claw part 57 and the disc 11, toward the disc 11. Thereby, the friction pad 18 moves in the disc axial direction and comes into contact with a surface of the disc 11 on the outer side.

In this way, the caliper 13 sandwiches the friction pads 17 and 18 from both sides between the piston 72 and the claw part 57 and presses them against both sides of the disc 11 due to the operation of the piston 72. As a result, the caliper 13 applies frictional resistance to the disc 11 to generate a braking force. The caliper 13 is a floating type caliper, and is a fist type caliper.

The disc brake described in Patent Document 1 described above has a structure in which an assembly part is provided with a claw part and is locked to a caliper to improve ease of attachment and detachment of the assembly part in the caliper. In this disc brake, movement of a seam in a rotation direction of the seam is restricted by assembling the seam to a back plate of an outer pad using the claw part. Incidentally, there are cases in which a cover member is provided on the caliper for the purpose of improving design quality or the like. In such a case, it is desirable to maintain the cover member in an appropriate state with respect to the caliper.

The disc brake 10 of the first embodiment includes the cover member 14 that has the plate part 161 covering the recessed portion 81 from the axial direction of the cylinder hole 71, and the locking parts 212 restricting movement of the plate part 161 in a rotation direction with respect to the axis of the recessed portion 81. Also, the plate 112 of the first embodiment includes the plate part 161 covering the recessed portion 81 from the axial direction of the cylinder hole 71, and the locking parts 212 restricting movement of the plate part 161 in a rotation direction with respect to the axis of the recessed portion 81. Therefore, the disc brake 10 and the plate 112 can restrict movement of the cover member 14 in the rotation direction with respect to the axis of the recessed portion 81. Therefore, the disc brake 10 and the plate 112 can maintain the cover member 14 in an appropriate state.

Also, in the disc brake 10, the locking parts 212 restrict movement of the plate part 161 in the rotation direction with respect to the axis of the recessed portion 81 by coming into contact with the recessed portion 81. Therefore, in the disc brake 10, the plate 112 including the plate part 161 and the locking parts 212 can be made smaller in size.

Also, in the disc brake 10, the plate part 161 and the locking parts 212 are formed as an integral part. Therefore, the disc brake 10 can minimize an increase in the number of parts and an increase in costs.

Also, in the disc brake 10, two locking parts 212 are provided for one plate part 161. Therefore, the disc brake 10 can share and receive a load with each of the locking parts 212, which can enhance durability of the locking parts 212.

### Second Embodiment

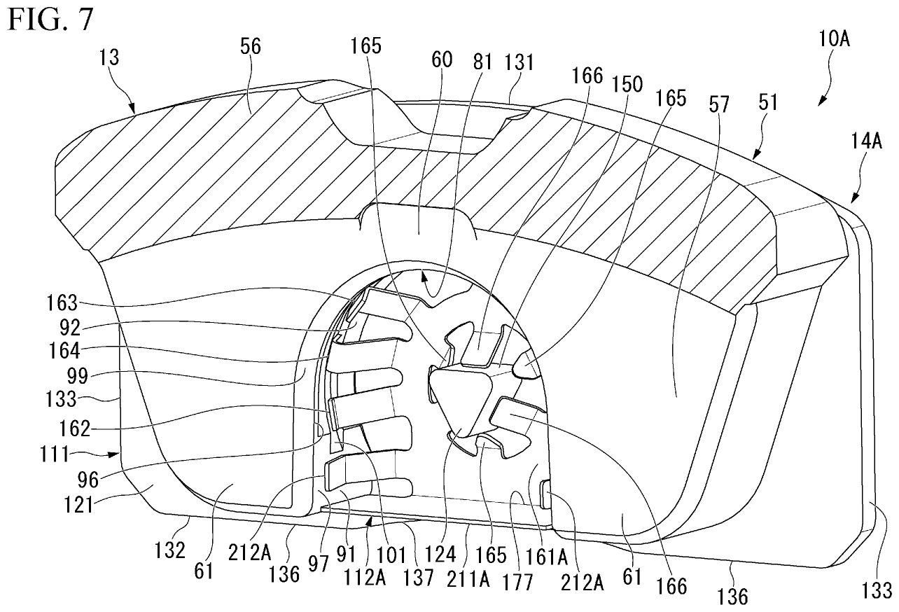

Next, a second embodiment will be described mainly on the basis of FIGS. 7 to 9, focusing on differences from the first embodiment. Further, portions common to those in the first embodiment will be denoted by the same terms and the same reference signs.

As illustrated in FIG. 7, a disc brake 10A of the second embodiment includes a cover member 14A, which is partially different from the cover member 14, instead of the cover member 14.

The cover member 14A includes a plate 112A, which is partially different from the plate 112, instead of the plate 112.

The plate 112A is also formed from a single spring steel plate by press forming. The plate 112A also has a mirror-symmetrical shape. The plate 112A includes a plate part 161A that is partially different from the plate part 161.

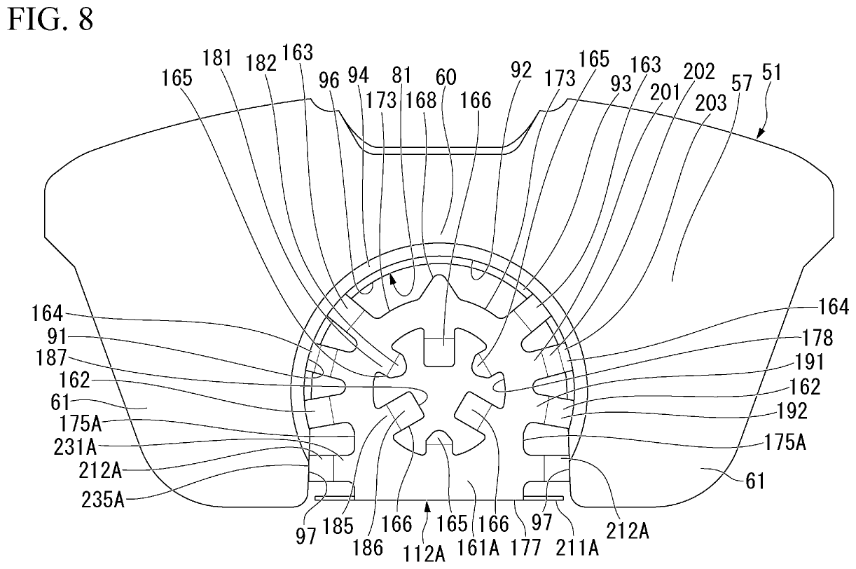

As illustrated in FIG. 8, the plate part 161A includes a pair of linear edge portions 175A instead of the pair of linear edge portions 175 and the pair of linear edge portions 176.

The pair of linear edge portions 175A extend in a direction opposite to a protruding part 168 from both end portions of a pair of arcuate edge portions 173 on a side opposite to the protruding part 168. The pair of linear edge portions 175A are mirror symmetrical and are parallel to each other.

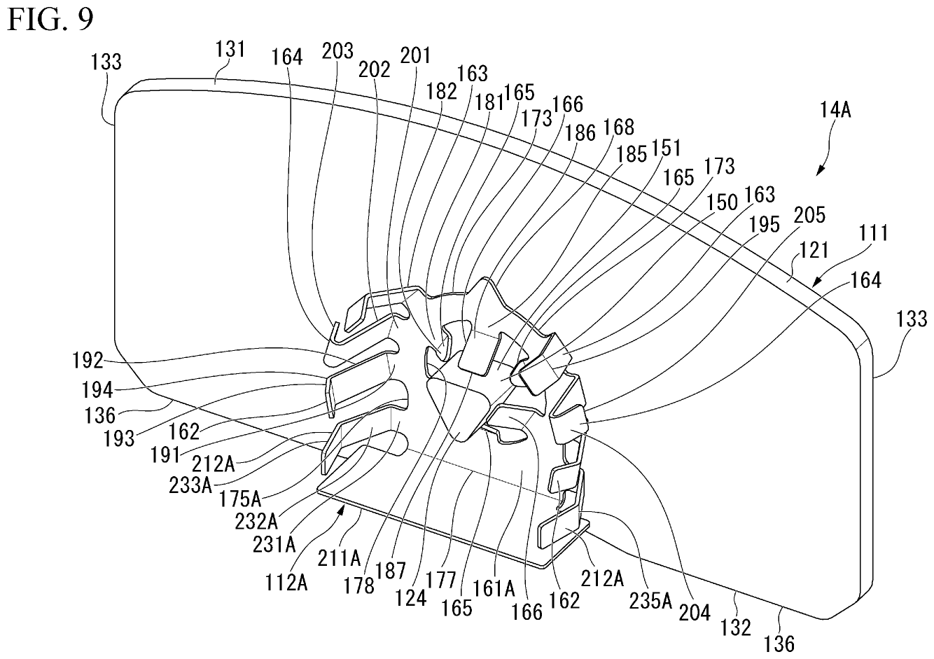

As illustrated in FIG. 9, the plate 112A includes a guard plate part 211A instead of the extension part 167. The guard plate part 211A is provided on a linear edge portion 177 and has the same shape as the guard plate part 211.

The plate 112A has a pair of locking parts 212A. The pair of locking parts 212A have the same shape. The pair of locking parts 212A extend from the plate part 161A to the same side as a pair of inwardly bent locking pieces 162, a pair of inwardly bent locking pieces 163, and a pair of outwardly bent locking pieces 164.

As illustrated in FIG. 8, one locking part 212A of the pair of locking parts 212A is provided on one linear edge portion 175A of the pair of linear edge portions 175A. The other locking part 212A of the pair of locking parts 212A is provided on the other linear edge portion 175A of the pair of linear edge portions 175A. The pair of locking parts 212A are provided at positions apart from the guard plate part 211A in the plate 112A.

The pair of locking parts 212A are disposed mirror-symmetrically. As illustrated in FIG. 9, the pair of locking parts 212A are disposed between the pair of inwardly bent locking pieces 162 and the guard plate part 211A.

The locking parts 212A each include an outer base plate part 231A, an intermediate plate part 232A, and a distal end plate part 233A. The outer base plate part 231A has a flat plate shape, and is disposed on the same plane as the plate part 161A. The outer base plate part 231A extends perpendicular to the linear edge portion 175A and outward in a direction in which the plate part 161A extends from the linear edge portion 175A on which it is provided.

The intermediate plate part 232A of the locking part 212A has a flat plate shape. The intermediate plate part 232A extends from an end edge portion of the adjacent outer base plate part 231A on an extending distal end side to one side in a thickness direction of the plate part 161A. The intermediate plate part 232A is inclined so that it is positioned further on a side opposite to the plate part 161A in a direction in which the plate part 161A extends with distance away from the plate part 161A in the thickness direction of the plate part 161A. The pair of locking parts 212A have a shape in which a distance between the intermediate plate parts 232A increases with distance away from the plate part 161A in the thickness direction of the plate part 161A. The intermediate plate part 232A forms an obtuse angle with the adjacent outer base plate part 231A.

The distal end plate part 233A of the locking part 212A has a flat plate shape. The distal end plate part 233A extends from an end edge portion of the adjacent intermediate plate part 232A on a side opposite to the outer base plate part 231A adjacent thereto to a side opposite to the plate part 161A in the thickness direction of the plate part 161A. The distal end plate part 233A is inclined such that it is positioned further on the plate part 161A in a direction in which the plate part 161A extends with distance away from the plate part 161A in the thickness direction of the plate part 161A. The pair of locking parts 212A have a shape in which a distance between the distal end plate parts 233A decreases with distance away from the plate part 161A in the thickness direction of the plate part 161A. The distal end plate part 233A forms an obtuse angle with the adjacent intermediate plate part 232A.

In the locking part 212A, a boundary portion 235A on a convex side between the intermediate plate part 232A and the distal end plate part 233A adjacent thereto is linear. The boundary portions 235A of the pair of locking parts 212A are parallel to each other and are parallel to the linear edge portion 175A.

The plate 112A is an integral part in which the plate part 161A, the pair of inwardly bent locking pieces 162, the pair of inwardly bent locking pieces 163, the pair of outwardly bent locking pieces 164, the three guide pieces 165, the three fixing pieces 166, the protruding part 168, the guard plate part 211A, and the pair of locking parts 212A are formed seamlessly.

In a state before the plate 112A is assembled to a caliper body 51 illustrated in FIG. 7, the pair of locking parts 212A are configured such that a minimum distance between outer sides of the distal end plate parts 233A in a direction in which the linear edge portion 177 illustrated in FIG. 9 extends is smaller than a minimum distance between the pair of end side surface portions 97 of the caliper body 51 illustrated in FIG. 8. Thereby, the pair of locking parts 212A can be easily inserted between the pair of end side surface portions 97 with a position farthest from the plate part 161A in the thickness direction of the plate part 161A at the front. Further, after the pair of locking parts 212A are inserted between the pair of end side surface portions 97, they are in contact with the pair of end side surface portions 97 as illustrated in FIG. 7. At that time, the pair of locking parts 212A elastically deform in a direction toward each other.

As illustrated in FIG. 9, the plate 112A is fitted onto a protruding part 124 of a cover main body member 111 with the three fixing pieces 166 and the three guide pieces 165 as in the first embodiment. Thereby, the plate 112A is fixed to the cover main body member 111 to form the cover member 14A. In this state, the plate 112A is configured such that the pair of inwardly bent locking pieces 162, the pair of inwardly bent locking pieces 163, the pair of outwardly bent locking pieces 164, the guard plate part 211A, and the pair of locking parts 212A extend to the same side as the protruding part 124 from a main plate part 121 of the cover main body member 111.

Then, the cover member 14A is assembled to a claw part 57 of the caliper body 51 as illustrated in FIG. 7. At that time, the cover member 14A is assembled to the claw part 57 from a side opposite to a cylinder part 55 (see FIG. 1) in an axial direction of a recessed portion 81.

When the cover member 14A is assembled to the claw part 57, the cover member 14A has a posture in which the pair of inwardly bent locking pieces 162, the pair of inwardly bent locking pieces 163, the pair of outwardly bent locking pieces 164, and the pair of locking parts 212A of the plate 112A are at the front in an assembly direction, and the main plate part 121 of the cover main body member 111 is at the rear in the assembly direction. At the same time, the cover member 14A has a posture in which a center of an inner circumferential edge portion 178 of the plate 112A is positioned approximately on an axis of the recessed portion 81, and the guard plate part 211A is positioned at a position farthest from the base portion 60 in the plate 112A.

In this state, the cover member 14A is moved to the recessed portion 81 side in the axial direction of the recessed portion 81. Then, in the cover member 14A, first, the pair of locking parts 212A of the plate 112A are inserted into the recessed portion 81 at the distal end plate part 233A. As the cover member 14A continues to move to the recessed portion 81 side, the pair of locking parts 212A come into contact with end edge portions of the pair of end side surface portions 97 on a side opposite to the cylinder part 55 (see FIG. 1) at the distal end plate parts 233A. As the cover member 14A continues to move further to the recessed portion 81 side, the pair of locking parts 212A ride on the pair of end side surface portions 97 of the recessed portion 81 while being elastically deformed toward each other due to inclinations of the distal end plate parts 233A. Thereby, as illustrated in FIG. 8, the boundary portions 235A of the pair of locking parts 212A come into contact with the pair of end side surface portions 97 of the recessed portion 81 with a fastening allowance.

As the cover member 14A continues to move to the recessed portion 81 side after the insertion of the pair of locking parts 212A into the recessed portion 81 has started as described above, the pair of inwardly bent locking pieces 162, the pair of inwardly bent locking pieces 163, and the pair of outwardly bent locking pieces 164 of the plate 112A engage with the groove 101 of the recessed portion 81 illustrated in FIG. 7 as in the first embodiment. At the same time, the cover main body member 111 comes into contact with the bridge part 56 and the claw part 57 of a caliper 13 at the main plate part 121 and stops.

In this way, the cover member 14A is attached to the caliper 13. In an assembled state in which the cover member 14A is assembled to the caliper 13 in this manner, the pair of locking parts 212A of the cover member 14A are in contact with the pair of end side surface portions 97 of the recessed portion 81 with a fastening allowance. That is, one locking part 212A of the pair of locking parts 212A is in contact with one end side surface portion 97 of the pair of end side surface portions 97 with a fastening allowance. At the same time, the other locking part 212A of the pair of locking parts 212A is in contact with the other end side surface portion 97 of the pair of end side surface portions 97 with a fastening allowance.

In the assembled state, the pair of locking parts 212A of the plate 112A of the cover member 14A restrict movement of the plate part 161A in a rotation direction with respect to the axis of the recessed portion 81. That is, in the plate 112A, one locking part 212A of the pair of locking parts 212A is in contact with one end side surface portion 97 of the pair of end side surface portions 97 of the recessed portion 81. Thereby, movement of the plate part 161A to one side in the rotation direction with respect to the axis of the recessed portion 81 is restricted. At the same time, in the plate 112A, the other locking part 212A of the pair of locking parts 212A is in contact with the other end side surface portion 97 of the pair of end side surface portions 97 of the recessed portion 81. Thereby, movement of the plate part 161A to the other side in the rotation direction with respect to the axis of the recessed portion 81 is restricted. In this way, the pair of locking parts 212A of the plate 112A restrict movement of the plate part 161A in the rotation direction with respect to the axis of the recessed portion 81. In other words, the pair of locking parts 212A restrict movement of the plate part 161A in the rotation direction with respect to the axis of the recessed portion 81 by coming into contact with the pair of end side surface portions 97 of the recessed portion 81. In yet other words, the pair of locking parts 212A restrict rotation of the plate 112A centered on the axis of the recessed portion 81 and furthermore rotation of the cover member 14A by coming into contact with the pair of end side surface portions 97 of the recessed portion 81.

The disc brake 10A of the second embodiment includes the cover member 14A that has the plate part 161A covering the recessed portion 81 from the axial direction of the cylinder hole 71 (see FIG. 2), and the locking parts 212A restricting movement of the plate part 161A in a rotation direction with respect to the axis of the recessed portion 81. Also, the plate 112A of the second embodiment includes the plate part 161A covering the recessed portion 81 from the axial direction of the cylinder hole 71 (see FIG. 2), and the locking parts 212A restricting movement of the plate part 161A in a rotation direction with respect to the axis of the recessed portion 81. Therefore, the disc brake 10A and the plate 112A can restrict movement of the cover member 14A in the rotation direction with respect to the axis of the recessed portion 81. Therefore, the disc brake 10A and the plate 112A can maintain the cover member 14A in an appropriate state.

Also, in the disc brake 10A, the locking parts 212A restrict movement of the plate part 161A in the rotation direction with respect to the axis of the recessed portion 81 by coming into contact with the recessed portion 81. Therefore, in the disc brake 10A, the plate 112A including the plate part 161A and the locking parts 212A can be made smaller in size.

Also, in the disc brake 10A, the plate part 161A and the locking parts 212A are formed as an integral part. Therefore, the disc brake 10A can minimize an increase in the number of parts and an increase in costs.

Also, in the disc brake 10A, two locking parts 212A are provided for one plate part 161A. Therefore, the disc brake 10A can share and receive a load with each of the locking parts 212A, which can enhance durability of the locking parts 212A.

### Third Embodiment

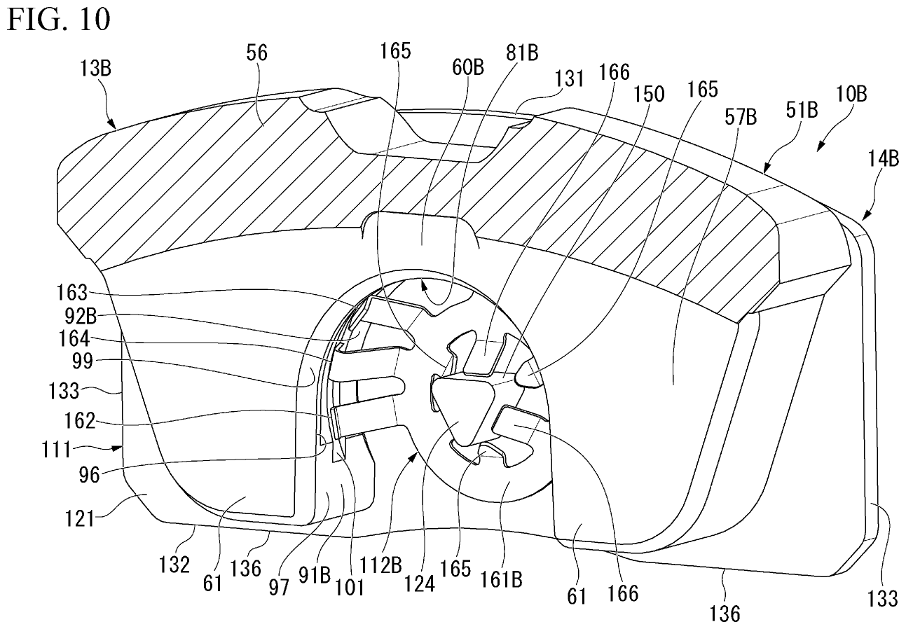

Next, a third embodiment will be described mainly on the basis of FIGS. 10 to 12, focusing on differences from the first embodiment. Further, portions common to those in the first embodiment will be denoted by the same terms and the same reference signs.

A disc brake 10B of the third embodiment illustrated in FIG. 10 includes a caliper 13B, which is partially different from the caliper 13, instead of the caliper 13.

The caliper 13B includes a caliper body 51B, which is partially different from the caliper body 51, instead of the caliper body 51.

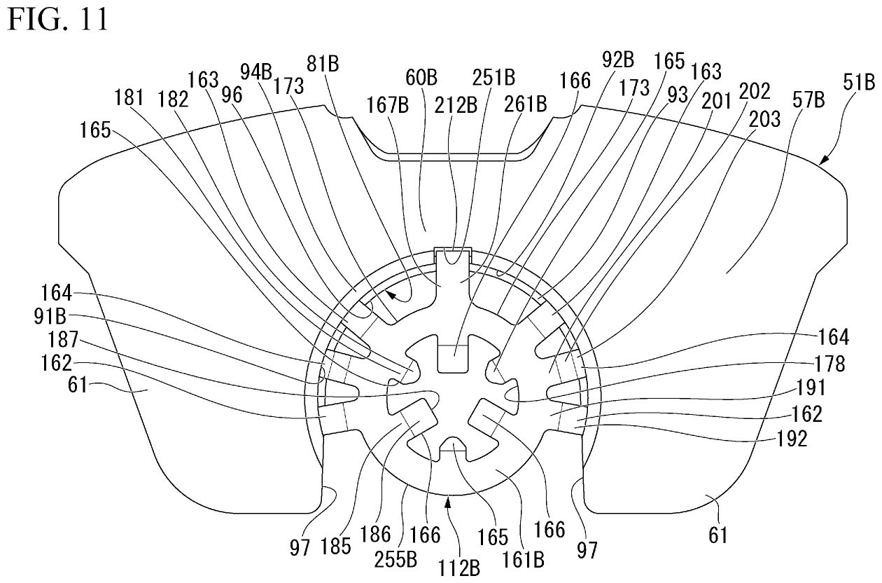

In the caliper body 51B, a claw part 57B is partially different from the claw part 57. As illustrated in FIG. 11, in the claw part 57B, a base portion 60B is partially different from the base portion 60. In the claw part 57B, a recessed portion 81B is partially different from the recessed portion 81.

A locking groove 251B is formed in the base portion 60B and the recessed portion 81B at a position closest to the base portion 60B side. Thereby, the recessed portion 81B has an inner surface 91B that differs from the inner surface 91 in that the locking groove 251B is formed thereon. The inner surface 91B has a main surface portion 92B that differs from the main surface portion 92 in that the locking groove 251B is formed thereon. The inner surface 91B has an outer chamfered portion 94B that differs from the outer chamfered portion 94 in that the locking groove 251B is formed thereon. The locking groove 251B is recessed outward in a radial direction of the main surface portion 92B from the main surface portion 92B. The locking groove 251B is provided at a central position in a direction connecting a pair of end side surface portions 97. In other words, the locking groove 251B is provided on the main surface portion 92 at a position farthest from the pair of end side surface portions 97. In yet other words, the locking groove 251B is provided on a radial reference line. The locking groove 251B extends to penetrate the outer chamfered portion 94B to a groove 101 illustrated in FIG. 10 in a direction of an axis of the recessed portion 81B.

The disc brake 10B of the third embodiment includes a cover member 14B, which is partially different from the cover member 14, instead of the cover member 14.

The cover member 14B includes a plate 112B, which is partially different from the plate 112, instead of the plate 112.

The plate 112B is also formed from a single spring steel plate by press forming. As illustrated in FIG. 11, the plate 112B also has a mirror-symmetrical shape. The plate 112B includes a plate part 161B that is partially different from the plate part 161.

An extension part 167B is provided in the plate part 161B instead of the protruding part 168. The plate 112B is an integral part in which the plate part 161B, a pair of inwardly bent locking pieces 162, a pair of inwardly bent locking pieces 163, a pair of outwardly bent locking pieces 164, three guide pieces 165, three fixing pieces 166, and the extension part 167B are formed seamlessly.

The plate part 161B does not include the extension part 167, and includes an arcuate edge portion 255B instead of the pair of linear edge portions 175, the pair of linear edge portions 176, and the linear edge portion 177. The arcuate edge portion 255B extends to connect end portions of the pair of arcuate edge portions 173 on a side opposite to the extension part 167B. The pair of arcuate edge portions 173 and the arcuate edge portion 255B each constitute a part of a concentric circle.

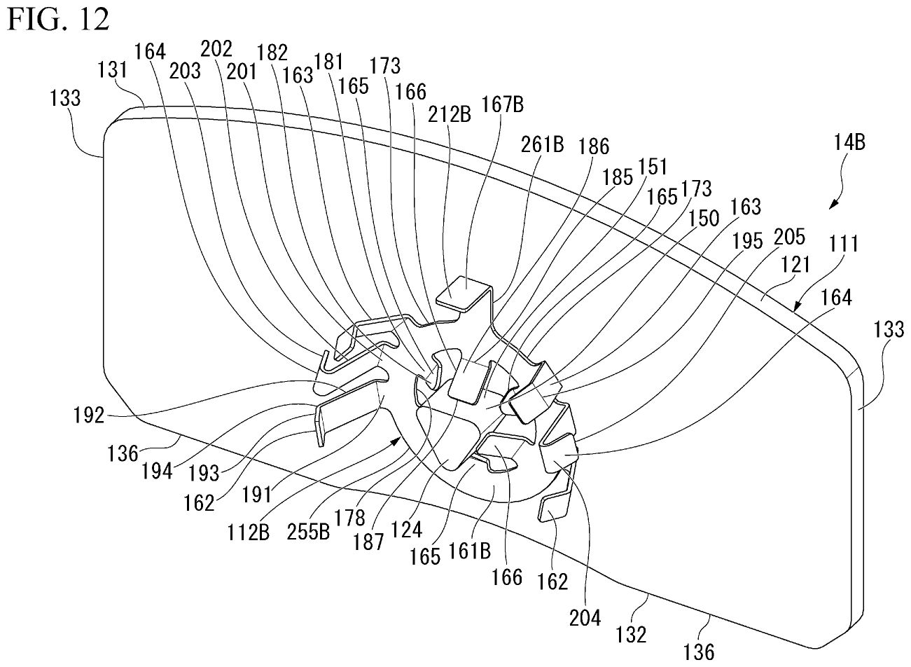

As illustrated in FIG. 12, the extension part 167B includes an outer base plate part 261B and a locking part 212B.

The outer base plate part 261B has a flat plate shape and is disposed on the same plane as the plate part 161B. The outer base plate part 261B extends outward in a radial direction of the pair of arcuate edge portions 173 from a position between the pair of arcuate edge portions 173 on a side opposite to the arcuate edge portion 255B.

The locking part 212B has a flat plate shape. The locking part 212B extends from an end edge portion of the outer base plate part 261B on an extending distal end side to one side in a thickness direction of the plate part 161B. The locking part 212B extends to the same side as the pair of inwardly bent locking pieces 162, the pair of inwardly bent locking pieces 163, and the pair of outwardly bent locking pieces 164 in the thickness direction of the plate part 161B. The locking part 212B is inclined so that it is positioned further inward in the radial direction of the pair of arcuate edge portions 173 with distance away from the plate part 161B in the thickness direction of the plate part 161B. The locking part 212B forms an acute angle with the outer base plate part 261B.

The extension part 167B is provided on a line that serves as a reference for mirror symmetry of the plate 112B.

The plate 112B is fitted onto a protruding part 124 of a cover main body member 111 with the three fixing pieces 166 and the three guide pieces 165 as in the first embodiment. Thereby, the plate 112B is fixed to the cover main body member 111 to form the cover member 14B. In this state, the plate 112B is configured such that the pair of inwardly bent locking pieces 162, the pair of inwardly bent locking pieces 163, the pair of outwardly bent locking pieces 164, and the extension part 167B extend to the same side as the protruding part 124 from a main plate part 121 of the cover main body member 111.

Then, the cover member 14B is assembled to the claw part 57B of the caliper body 51B as illustrated in FIG. 10. At that time, the cover member 14B is assembled to the claw part 57B from a side opposite to a cylinder part 55 (see FIG. 1) in an axial direction of the recessed portion 81B.

When the cover member 14B is assembled to the claw part 57B, the cover member 14B has a posture in which the pair of inwardly bent locking pieces 162, the pair of inwardly bent locking pieces 163, the pair of outwardly bent locking pieces 164, and the extension part 167B of the plate 112B are at the front in an assembly direction, and the main plate part 121 of the cover main body member 111 is at the rear in the assembly direction. At the same time, the cover member 14B has a posture in which a center of an inner circumferential edge portion 178 of the plate 112B is positioned approximately on the axis of the recessed portion 81B, and the extension part 167B is in phase with the locking groove 251B around the axis of the recessed portion 81B in the plate 112B.

In this state, the cover member 14B is moved to the recessed portion 81B side in the axial direction of the recessed portion 81B. Then, the pair of inwardly bent locking pieces 162, the pair of inwardly bent locking pieces 163, and the pair of outwardly bent locking pieces 164 of the plate 112B engage with the groove 101 of the recessed portion 81B as in the first embodiment. At the same time, the cover main body member 111 comes into contact with a bridge part 56 and the claw part 57B of the caliper 13B at the main plate part 121 and stops.

In the middle thereof, the locking part 212B of the plate 112B of the cover member 14B is inserted into the locking groove 251B.

In an assembled state in which the cover member 14B is assembled to the caliper 13B in this manner, the locking part 212B of the plate 112B of the cover member 14B restricts movement of the plate part 161B in the rotation direction with respect to the axis of the recessed portion 81B. That is, as illustrated in FIG. 11, the locking part 212B of the plate 112B fits into the locking groove 251B of the recessed portion 81B. Thereby, the locking part 212B of the plate 112B restricts movement of the plate part 161B to both sides in the rotation direction with respect to the axis of the recessed portion 81B. In other words, the locking part 212B restricts movement of the plate part 161B to both sides in the rotation direction with respect to the axis of the recessed portion 81B by coming into contact with the locking groove 251B of the recessed portion 81B. In yet other words, the locking part 212B restricts rotation of the plate 112B centered on the axis of the recessed portion 81B and furthermore rotation of the cover member 14B by coming into contact with the locking groove 251B of the recessed portion 81B.

The disc brake 10B of the third embodiment includes the cover member 14B that has the plate part 161B covering the recessed portion 81B from the axial direction of a cylinder hole 71 (see FIG. 2), and the locking part 212B restricting movement of the plate part 161B in the rotation direction with respect to the axis of the recessed portion 81B. Also, the plate 112B of the third embodiment includes the plate part 161B covering the recessed portion 81B from the axial direction of the cylinder hole 71 (see FIG. 2), and the locking part 212B restricting movement of the plate part 161B in the rotation direction with respect to the axis of the recessed portion 81B. Therefore, the disc brake 10B and the plate 112B can restrict movement of the cover member 14B in the rotation direction with respect to the axis of the recessed portion 81B. Therefore, the disc brake 10B and the plate 112B can maintain the cover member 14B in an appropriate state.

Also, in the disc brake 10B, the locking part 212B restricts movement of the plate part 161B in the rotation direction with respect to the axis of the recessed portion 81B by coming into contact with the recessed portion 81B. Therefore, in the disc brake 10B, the plate 112B including the plate part 161B and the locking part 212B can be made smaller in size.

Also, in the disc brake 10B, the plate part 161B and the locking part 212B are formed as an integral part. Therefore, the disc brake 10B can minimize an increase in the number of parts and an increase in costs.

Also, in the disc brake 10B, one locking part 212B is provided for the plate part 161B. Therefore, in the disc brake 10B, a reduction in weight of the plate 112B can be achieved.

### Fourth Embodiment

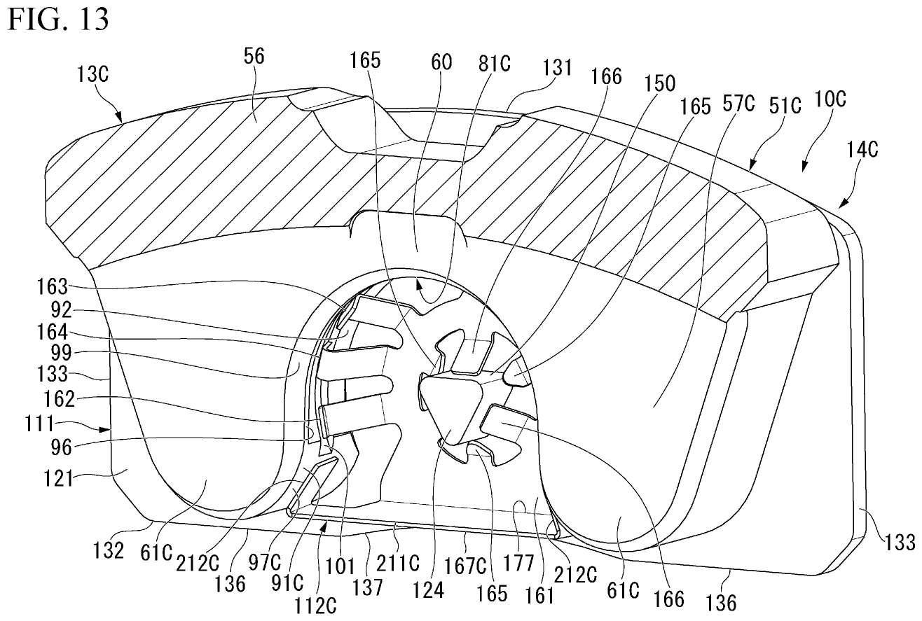

Next, a fourth embodiment will be described mainly on the basis of FIGS. 13 to 15, focusing on differences from the first embodiment. Further, portions common to those in the first embodiment will be denoted by the same terms and the same reference signs.

As illustrated in FIG. 13, a disc brake 10C of the fourth embodiment includes a caliper 13C, which is partially different from the caliper 13, instead of the caliper 13.

The caliper 13C includes a caliper body 51C, which is partially different from the caliper body 51, instead of the caliper body 51.

In the caliper body 51C, a claw part 57C is partially different from the claw part 57. In the claw part 57C, a pair of claw main body portions 61C are partially different from the pair of claw main body portions 61. In the claw part 57C, a recessed portion 81C is partially different from the recessed portion 81.

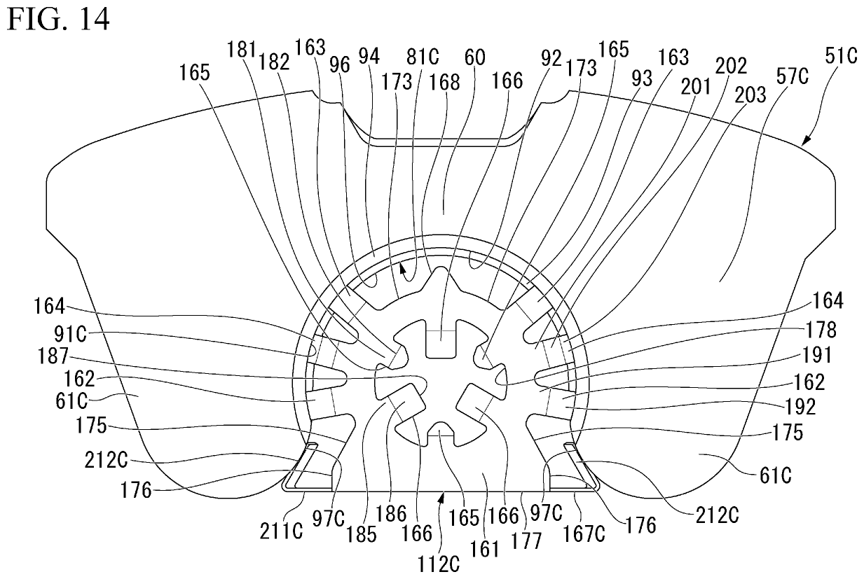

As illustrated in FIG. 14, a pair of end side surface portions 97C are provided in the pair of claw main body portions 61C and the recessed portion 81C instead of the pair of end side surface portions 97. Therefore, the recessed portion 81C has an inner surface 91C that differs from the inner surface 91 in that the pair of end side surface portions 97C are provided. The pair of end side surface portions 97C each extend from an end edge portion of a main surface portion 92 on a side opposite to a base portion 60, that is, on a disc radial direction inward side, to a disc radial direction inward side and a disc circumferential direction outward side. The pair of end side surface portions 97C each have a shape of a part of a cylindrical surface. A central axis of curvature of the end side surface portion 97C extends along an axis of the recessed portion 81C. The central axis of curvature of the end side surface portion 97C is disposed inside the claw main body portion 61C in which the end side surface portion 97C is formed. The end side surface portion 97C has an R-chamfered shape.

As illustrated in FIG. 13, the disc brake 10C of the fourth embodiment includes a cover member 14C, which is partially different from the cover member 14, instead of the cover member 14.

The cover member 14C includes a plate 112C, which is partially different from the plate 112, instead of the plate 112.

The plate 112C is also formed from a single spring steel plate by press forming. The plate 112C also has a mirror-symmetrical shape as illustrated in FIG. 14. The plate 112C includes an extension part 167C that is partially different from the extension part 167. The plate 112C is an integral part in which a plate part 161, a pair of inwardly bent locking pieces 162, a pair of inwardly bent locking pieces 163, a pair of outwardly bent locking pieces 164, three guide pieces 165, three fixing pieces 166, the extension part 167C, and a protruding part 168 are formed seamlessly.

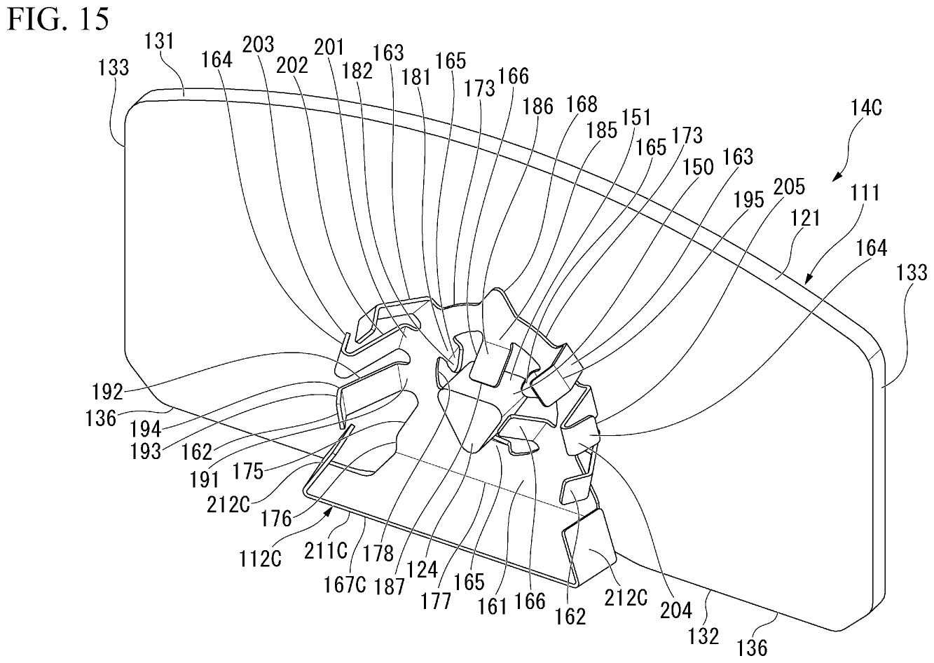

As illustrated in FIG. 15, the extension part 167C includes a guard plate part 211C and a pair of locking parts 212C. Therefore, two locking parts 212C are provided for one plate part 161.

The guard plate part 211C is substantially the same as the guard plate part 211, and a length thereof is longer than a length of the guard plate part 211 in a direction in which a linear edge portion 177 extends.

The pair of locking parts 212C have the same shape. The pair of locking parts 212C have the same shape as the pair of locking parts 212, and an angle thereof formed with the guard plate part 211C is different from an angle formed by the pair of locking parts 212 and the guard plate part 211. That is, as illustrated in FIG. 15, a distance between the pair of locking parts 212C in a direction in which the linear edge portion 177 extends decreases with distance away from the guard plate part 211C in a thickness direction of the guard plate part 211C. In other words, the pair of locking parts 212C each form the same acute angle with respect to the guard plate part 211C as illustrated in FIG. 15.

The plate 112C is fitted onto a protruding part 124 of the cover main body member 111 with the three fixing pieces 166 and the three guide pieces 165 as in the first embodiment. Thereby, the plate 112C is fixed to the cover main body member 111 to form the cover member 14C. In this state, the plate 112C is configured such that the pair of inwardly bent locking pieces 162, the pair of inwardly bent locking pieces 163, the pair of outwardly bent locking pieces 164, and the extension part 167C extend to the same side as the protruding part 124 from a main plate part 121 of the cover main body member 111.

Then, the cover member 14C is assembled to the claw part 57C of the caliper body 51C as illustrated in FIG. 13. At that time, the cover member 14C is assembled to the claw part 57C from a side opposite to a cylinder part 55 (see FIG. 1) in an axial direction of the recessed portion 81C.

When the cover member 14C is assembled to the claw part 57C, the cover member 14C has a posture in which the pair of inwardly bent locking pieces 162, the pair of inwardly bent locking pieces 163, the pair of outwardly bent locking pieces 164, and the extension part 167C of the plate 112C are at the front in an assembly direction, and the main plate part 121 of the cover main body member 111 is at the rear in the assembly direction. At the same time, the cover member 14C has a posture in which a center of an inner circumferential edge portion 178 of the plate 112C is positioned approximately on the axis of the recessed portion 81C, and the extension part 167C is positioned at a position farthest from the base portion 60 in the plate 112C.

In this state, the cover member 14C is moved to the recessed portion 81C side in the axial direction of the recessed portion 81C. Then, in the cover member 14C, first, the pair of locking parts 212C of the extension part 167C of the plate 112C are inserted into the recessed portion 81C. As the cover member 14C continues to move to the recessed portion 81C side, the pair of locking parts 212C come into contact with the end edge portions of the pair of end side surface portions 97C on a side opposite to the cylinder part 55 (see FIG. 1). As the cover member 14C continues to move further to the recessed portion 81C side, the pair of locking parts 212C ride on the pair of end side surface portions 97C of the recessed portion 81C while being elastically deformed toward each other due to their inclinations. Thereby, the pair of locking parts 212C come into contact with the pair of end side surface portions 97C of the recessed portion 81C with a fastening allowance.

As the cover member 14C continues to move to the recessed portion 81C side after the insertion of the pair of locking parts 212C into the recessed portion 81C has started as described above, the pair of inwardly bent locking pieces 162, the pair of inwardly bent locking pieces 163, and the pair of outwardly bent locking pieces 164 of the plate 112C engage with a groove 101 of the recessed portion 81 as in the first embodiment. At the same time, the cover main body member 111 comes into contact with a bridge part 56 and the claw part 57C of the caliper 13 at the main plate part 121 and stops.

In this way, the cover member 14C is attached to the caliper 13C. In an assembled state in which the cover member 14C is assembled to the caliper 13C in this manner, the pair of locking parts 212C of the cover member 14C are in contact with the pair of end side surface portions 97C of the recessed portion 81C with a fastening allowance. That is, one locking part 212C of the pair of locking parts 212C is in contact with one end side surface portion 97C of the pair of end side surface portions 97C with a fastening allowance. At the same time, the other locking part 212C of the pair of locking parts 212C is in contact with the other end side surface portion 97C of the pair of end side surface portions 97C with a fastening allowance.

In the assembled state, the pair of locking parts 212C of the plate 112C of the cover member 14C restrict movement of the plate part 161 in a rotation direction with respect to the axis of the recessed portion 81C. That is, in the plate 112C, one locking part 212C of the pair of locking parts 212C is in contact with one end side surface portion 97C of the pair of end side surface portions 97C of the recessed portion 81C. Thereby, the plate 112C restricts movement of the plate part 161 to one side in the rotation direction with respect to the axis of the recessed portion 81C. At the same time, in the plate 112C, the other locking part 212C of the pair of locking parts 212C is in contact with the other end side surface portion 97C of the pair of end side surface portions 97C of the recessed portion 81C. Thereby, the plate 112C restricts movement of the plate part 161 to the other side in the rotation direction with respect to the axis of the recessed portion 81C. In this way, the pair of locking parts 212C of the plate 112C restrict movement of the plate part 161 in the rotation direction with respect to the axis of the recessed portion 81C. In other words, the pair of locking parts 212C restrict movement of the plate part 161 in the rotation direction with respect to the axis of the recessed portion 81C by coming into contact with the pair of end side surface portions 97C of the recessed portion 81C. In yet other words, the pair of locking parts 212C restrict rotation of the plate 112C centered on the axis of the recessed portion 81C and furthermore rotation of the cover member 14C by coming into contact with the pair of end side surface portions 97C of the recessed portion 81C.

The disc brake 10C of the fourth embodiment includes the cover member 14C that has the plate part 161 covering the recessed portion 81C from the axial direction of a cylinder hole 71 (see FIG. 2), and the locking parts 212C restricting movement of the plate part 161 in the rotation direction with respect to the axis of the recessed portion 81C. Also, the plate 112C of the fourth embodiment includes the plate part 161 covering the recessed portion 81C from the axial direction of the cylinder hole 71 (see FIG. 2), and the locking parts 212C restricting movement of the plate part 161 in the rotation direction with respect to the axis of the recessed portion 81C. Therefore, the disc brake 10C and the plate 112C can restrict movement of the cover member 14C in the rotation direction with respect to the axis of the recessed portion 81C. Therefore, the disc brake 10C and the plate 112C can maintain the cover member 14C in an appropriate state.

Also, in the disc brake 10C, the locking parts 212C restrict movement of the plate part 161 in the rotation direction with respect to the axis of the recessed portion 81C by coming into contact with the recessed portion 81C. Therefore, in the disc brake 10C, the plate 112C including the plate part 161 and the locking parts 212C can be made smaller in size.

Also, in the disc brake 10C, the plate part 161 and the locking parts 212C are formed as an integral part. Therefore, the disc brake 10C can minimize an increase in the number of parts and an increase in costs.

Also, in the disc brake 10C, two locking parts 212C are provided for one plate part 161. Therefore, the disc brake 10C can share and receive a load with each of the locking parts 212C, which can enhance durability of the locking parts 212C.

### Fifth Embodiment

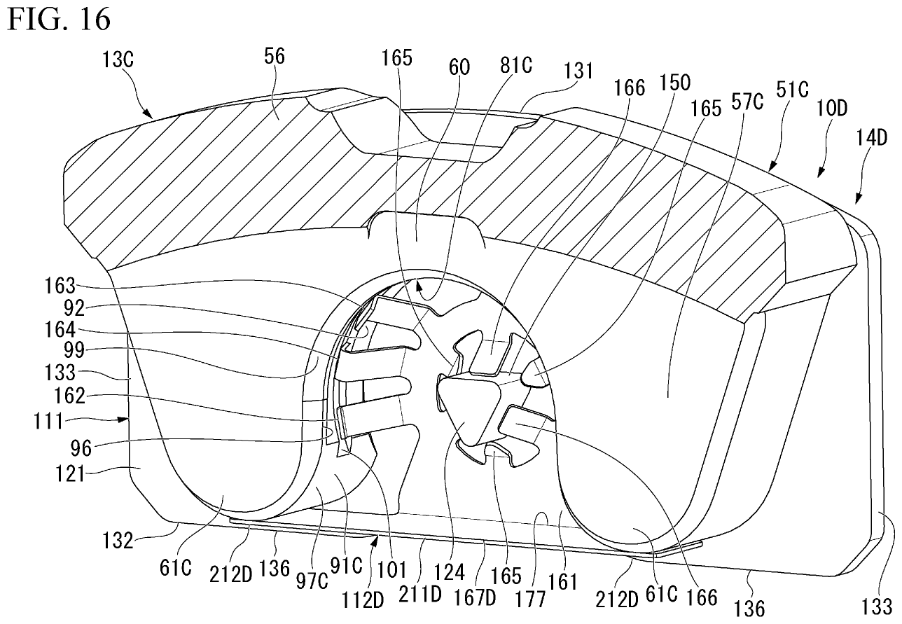

Next, a fifth embodiment will be described mainly on the basis of FIGS. 16 to 18, focusing on differences from the fourth embodiment. Further, portions common to those in the fourth embodiment will be denoted by the same terms and the same reference signs.

A disc brake 10D of the fifth embodiment illustrated in FIG. 16 includes a cover member 14D, which is partially different from the cover member 14C, instead of the cover member 14C.

The cover member 14D includes a plate 112D, which is partially different from the plate 112C of the cover member 14C, instead of the plate 112C.

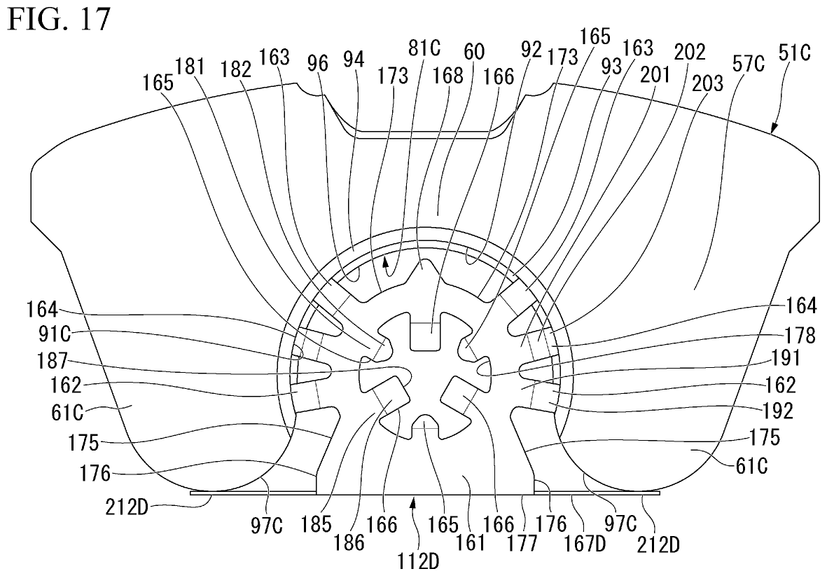

The plate 112D is also formed from a single spring steel plate by press forming. The plate 112D also has a mirror-symmetrical shape as illustrated in FIG. 17. The plate 112D includes an extension part 167D that is partially different from extension part 167C. The plate 112D is an integral part in which a plate part 161, a pair of inwardly bent locking pieces 162, a pair of inwardly bent locking pieces 163, a pair of outwardly bent locking pieces 164, three guide pieces 165, three fixing pieces 166, the extension part 167D, and a protruding part 168 are formed seamlessly.

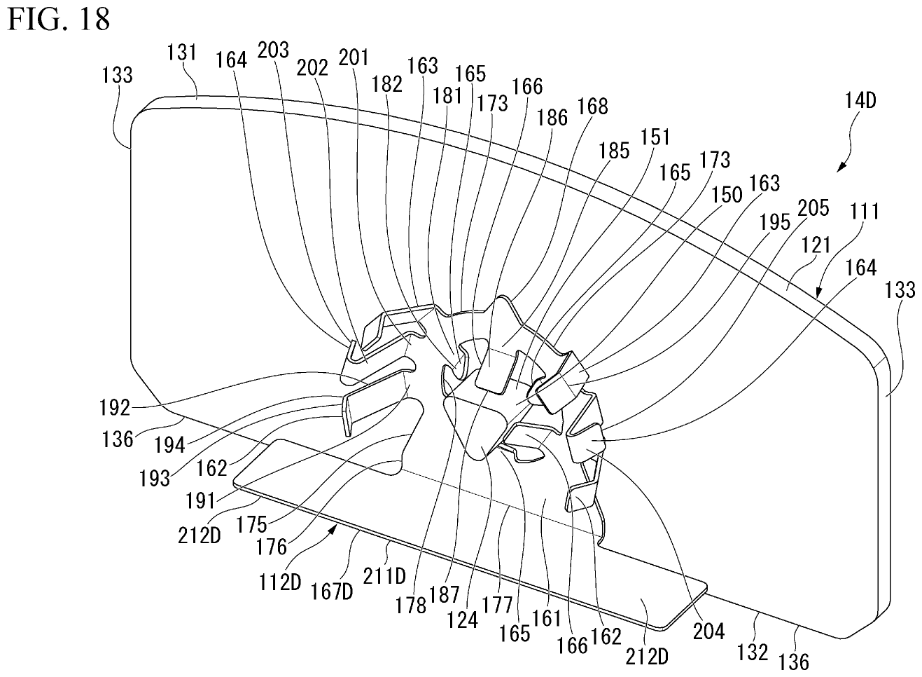

As illustrated in FIG. 18, the extension part 167D includes a guard plate part 211D and a pair of locking parts 212D. Therefore, two locking parts 212D are provided for one plate part 161.

The guard plate part 211D has a flat plate shape similar to the guard plate part 211C of the extension part 167C.

The pair of locking parts 212D have the same shape. The pair of locking parts 212D extend in a direction away from the guard plate part 211D in a direction in which a linear edge portion 177 extends on both sides of the guard plate part 211D in the direction in which the linear edge portion 177 extends. The pair of locking parts 212D extend to be coplanar with the guard plate part 211D. The pair of locking parts 212D and the guard plate part 211D are formed in one flat plate shape as a whole.

The plate 112D is fitted onto a protruding part 124 of a cover main body member 111 with the three fixing pieces 166 and the three guide pieces 165 as in the fourth embodiment. Thereby, the plate 112D is fixed to the cover main body member 111 to form the cover member 14D. In this state, the plate 112D is configured such that the pair of inwardly bent locking pieces 162, the pair of inwardly bent locking pieces 163, the pair of outwardly bent locking pieces 164, and the extension part 167D extend to the same side as the protruding part 124 from a main plate part 121 of the cover main body member 111.

Then, the cover member 14D is assembled to a claw part 57C of a caliper body 51C as illustrated in FIG. 16. At that time, the cover member 14D is assembled to the claw part 57C from a side opposite to a cylinder part 55 (see FIG. 1) in an axial direction of a recessed portion 81C.

When the cover member 14D is assembled to the claw part 57C, the cover member 14D has a posture in which the pair of inwardly bent locking pieces 162, the pair of inwardly bent locking pieces 163, the pair of outwardly bent locking pieces 164, and the extension part 167D of the plate 112D are at the front in an assembly direction, and the main plate part 121 of the cover main body member 111 is at the rear in the assembly direction. At the same time, the cover member 14D has a posture in which a center of an inner circumferential edge portion 178 of the plate 112D is positioned approximately on an axis of the recessed portion 81C, and the extension part 167D is positioned at a position farthest from a base portion 60 in the plate 112D.

In this state, the cover member 14D is moved to the recessed portion 81C side in an axial direction of the recessed portion 81C. Then, in the cover member 14D, first, the pair of locking parts 212D of the extension part 167D of the plate 112D come into contact with end portions of a pair of claw main body portions 61C on a side opposite to the base portion 60. That is, in the cover member 14D, one locking part 212D of the pair of locking parts 212D comes into contact with an end portion of one claw main body portion 61C of the pair of claw main body portions 61C on a side opposite to the base portion 60. At the same time, in the cover member 14D, the other locking part 212D of the pair of locking parts 212D comes into contact with an end portion of the other claw main body portion 61C of the pair of claw main body portions 61C on a side opposite to the base portion 60. In other words, in the cover member 14D, the pair of locking parts 212D of the extension part 167D of the plate 112D overlap end portions on a disc radial direction inward side of the pair of claw main body portions 61C in both a position in a disc axial direction and a position in a disc circumferential direction.

Thereafter, as the cover member 14D continues to move to the recessed portion 81C side, the pair of inwardly bent locking pieces 162, the pair of inwardly bent locking pieces 163, and the pair of outwardly bent locking pieces 164 of the plate 112D engage with a groove 101 of the recessed portion 81 as in the first embodiment. At the same time, the cover main body member 111 comes into contact with a bridge part 56 and the claw part 57C of a caliper 13 at the main plate part 121 and stops.

In this way, the cover member 14D is attached to the caliper 13C. In an assembled state in which the cover member 14D is assembled to the caliper 13C in this manner, the pair of locking parts 212D of the cover member 14D are in contact with end portions of the pair of claw main body portions 61C on a side opposite to the base portions 60. In other words, in the assembled state, the pair of locking parts 212D of the plate 112D of the cover member 14D are in contact with an end portion of the claw part 57C on a disc radial direction inward side.

In the assembled state, the pair of locking parts 212D of the plate 112D of the cover member 14D restrict movement of the plate part 161 in a rotation direction with respect to the axis of the recessed portion 81C. That is, in the plate 112D, one locking part 212D of the pair of locking parts 212D is in contact with an end portion of one claw main body portion 61C of the pair of claw main body portions 61C on a side opposite to the base portion 60. Thereby, the plate 112D restricts movement of the plate part 161 to one side in the rotation direction with respect to the axis of the recessed portion 81C. At the same time, in the plate 112D, the other locking part 212D of the pair of locking parts 212D is in contact with an end portion of the other claw main body portion 61C of the pair of claw main body portions 61C on a side opposite to the base portion 60. Thereby, the plate 112D restricts movement of the plate part 161 to the other side in the rotation direction with respect to the axis of the recessed portion 81C. In this way, the pair of locking parts 212D of the plate 112D restrict movement of the plate part 161 in the rotation direction with respect to the axis of the recessed portion 81C. In other words, the pair of locking parts 212D restrict movement of the plate part 161 in the rotation direction with respect to the axis of the recessed portion 81C by coming into contact with end portions of the pair of claw main body portions 61C on a side opposite to the base portions 60. In yet other words, the pair of locking parts 212D restrict rotation of the plate 112D centered on the axis of the recessed portion 81C and furthermore rotation of the cover member 14D by coming into contact with the end portions of the pair of claw main body portions 61C on a side opposite to the base portions 60.

The disc brake 10D of the fifth embodiment includes the cover member 14D that has the plate part 161 covering the recessed portion 81C from the axial direction of a cylinder hole 71 (see FIG. 2), and the locking parts 212D restricting movement of the plate part 161 in the rotation direction with respect to the axis of the recessed portion 81C. Also, the plate 112D of the fifth embodiment includes the plate part 161 covering the recessed portion 81C from the axial direction of the cylinder hole 71 (see FIG. 2), and the locking parts 212D restricting movement of the plate part 161 in the rotation direction with respect to the axis of the recessed portion 81C. Therefore, the disc brake 10D and the plate 112D can restrict movement of the cover member 14D in the rotation direction with respect to the axis of the recessed portion 81C. Therefore, the disc brake 10D and the plate 112D can maintain the cover member 14D in an appropriate state.

Also, in the disc brake 10D, the locking parts 212D restrict movement of the plate part 161 in the rotation direction with respect to the axis of the recessed portion 81C by coming into contact with the end portion of the claw part 57C on the disc radial direction inward side. Therefore, in the disc brake 10D, a shape of the extension part 167D including the locking parts 212D can be simplified.

Further, in the disc brake 10D, the plate part 161 and the locking parts 212D are formed as an integral part. Therefore, the disc brake 10D can minimize an increase in the number of parts and an increase in costs.

Also, in the disc brake 10D, two locking parts 212D are provided for one plate part 161. Therefore, the disc brake 10D can share and receive a load with each of the locking parts 212D, which can enhance durability of the locking parts 212D.

Further, the cover member 14D including the plate 112D of the fifth embodiment may be provided for the caliper 13 of the first embodiment instead of the cover member 14. With this configuration, the pair of locking parts 212D come into contact with end portions of the pair of claw main body portions 61 on a side opposite to the base portions 60.

Also, the third embodiment can be combined with the first, second, fourth, and fifth embodiments. For example, the extension part 167B of the third embodiment, and a plate having the extension part 167 of the first embodiment, the pair of locking parts 212A of the second embodiment, or the pair of locking parts 212D of the fifth embodiment can be used for the caliper 13B of the third embodiment. That is, a plate having a total of three locking parts including the locking part 212B and the pair of locking parts 212 is used. Alternatively, a plate having a total of three locking parts including the locking part 212B and the pair of locking parts 212A is used. Alternatively, a plate having a total of three locking parts including the locking part 212B and the pair of locking parts 212D is used. In these cases, three locking parts, which are two or more locking parts, restricting rotation of the plate part around the axis of the recessed portion are provided for one plate part. As a matter of course, three or more locking parts restricting rotation of the plate part around the axis of the recessed portion may be provided for one plate part.

Also, cases in which the plate part 161 and the locking part 212 are an integral part in the first embodiment, the plate part 161A and the locking part 212A are an integral part in the second embodiment, the plate part 161B and the locking part 212B are an integral part in the third embodiment, the plate part 161 and the locking part 212C are an integral part in the fourth embodiment, and the plate part 161 and the locking part 212D are an integral part in the fifth embodiment have been described with respective examples. In contrast to these, it is also possible to configure such that the plate part 161 and the locking part 212 are made to be separate parts in the first embodiment, the plate part 161A and the locking part 212A are made to be separate parts in the second embodiment, the plate part 161B and the locking part 212B are made to be separate parts in the third embodiment, the plate part 161 and the locking part 212C are made to be separate in the fourth embodiment, and the plate part 161 and the locking part 212D are made to be separate parts in the fifth embodiment. With these configurations, the plate part can be used as a common part, and the plate can be formed by changing the locking part according to a shape of the caliper. As a result, it is possible to use the plate part as a common part for calipers of various shapes.

### INDUSTRIAL APPLICABILITY

According to the above-described aspects, it is possible to provide a disc brake and a plate capable of maintaining a cover member in an appropriate state with respect to a caliper. Therefore, industrial applicability is significant.

### REFERENCE SIGNS LIST

10, 10A to 10D Disc brake
11 Disc
13, 13B Caliper
14, 14A to 14D Cover member
17, 18 Friction pad
55 Cylinder part
56 Bridge part
57, 57B, 57D Claw part
71 Cylinder hole
72 Piston
81, 81B, 81C Recessed portion
112, 112A to 112D Plate
161, 161A, 161B Plate part
212, 212A to 212D Locking part

1. A disc brake comprising:
a caliper; and
a cover member attached to the caliper, wherein
the caliper includes:
a piston pressing a friction pad;
a cylinder part having a cylinder hole in which the piston is accommodated;
a bridge part provided to straddle an outer circumferential side of a disc from the cylinder part;
a claw part provided to face the cylinder part in an axial direction of the cylinder hole from the bridge part; and
a recessed portion provided in the claw part to face the cylinder hole, and
the cover member includes:
a plate part covering the recessed portion from the axial direction of the cylinder hole; and
a locking part restricting movement of the plate part in a rotation direction with respect to an axis of the recessed portion.

2. The disc brake according to claim 1, wherein movement of the plate part in a rotation direction with respect to the axis of the recessed portion is restricted by the locking part coming into contact with the recessed portion.

3. The disc brake according to claim 1, wherein the plate part and the locking part are an integral part.

4. The disc brake according to claim 1, wherein the plate part and the locking part are separate parts.

5. The disc brake according to claim 1, wherein one locking part is provided for the plate part.

6. The disc brake according to claim 1, wherein two or more locking parts are provided for the plate part.

7. A plate which is provided in a caliper including:
a piston pressing a friction pad;
a cylinder part having a cylinder hole in which the piston is accommodated;
a bridge part provided to straddle an outer circumferential side of a disc from the cylinder part;
a claw part provided to face the cylinder part in an axial direction of the cylinder hole from the bridge part; and
a recessed portion provided in the claw part to face the cylinder hole,
the plate comprising:
a plate part covering the recessed portion from the axial direction of the cylinder hole; and
a locking part restricting movement of the plate part in a rotation direction with respect to an axis of the recessed portion.
